(19) United States
(12) Patent Application Publication
(10) Pub. No.: US 2021/0258623 A1
(43) Pub. Date: Aug. 19, 2021

(54) REMOTE FOLDERS FOR REAL TIME REMOTE COLLABORATION

(71) Applicant: Evercast, LLC, Scottsdale, AZ (US)

(72) Inventors: Alex Cyrell, Paradise Valley, AZ (US); Brad Thomas Ahlf, Scottsdale, AZ (US); Jon Walkenhorst, Orlando, FL (US); Marcie Jastrow, Los Angeles, CA (US); Roger Patrick Barton, Pacific Palisades, CA (US); Chad Andrew Furman, Holyoke, MA (US); Steven Barry Cohen, Long Beach, CA (US); Damien Phelan Stolarz, Los Angeles, CA (US)

(21) Appl. No.: 17/179,381

(22) Filed: Feb. 18, 2021

Related U.S. Application Data
(63) Continuation-in-part of application No. 17/139,472, filed on Dec. 31, 2020.
Application No. 17/139,472 is a continuation of application No. 16/794,962, filed on Feb. 19, 2020, now Pat. No. 10,887,633.
(60) Provisional application No. 62/978,554, filed on Feb. 19, 2020.

(51) Int. Cl. H04N 21/2343; H04N 21/2387; H04L 29/06

(52) U.S. Cl. CPC H04N 21/23439; H04N 21/234381; H04L 65/4092; H04N 21/234363; H04L 65/604; H04N 21/2387

(57) ABSTRACT

Described are systems and methods that enable secure real time communication (“RTC”) sessions that may be used, for example, for editing and movie production. Client devices may interact with an RTC management system to collaborate on different files retained on the different client devices, without the files having to be uploaded from the client device on which it is stored. In addition, on-going multifactor authentication may be performed for each client device of an RTC session during the RTC session and/or video authentication may be used to grant access into an RTC session. Still further, to improve the quality of the exchanged video information and to reduce transmission requirements, in response to detection of events, such as a pause event, a high resolution image of a paused video may be generated and sent for presentation on the display of each client device, instead of continuing to stream a paused video.

### PRIORITY CLAIM

This application claims priority to U.S. Provisional Application No. 62/978,554, filed Feb. 19, 2020, and titled “Real Time Remote Video Collaboration With Feedback,” and is a Continuation-In-Part of U.S. patent application Ser. No. 17/139,472, filed Dec. 31, 2020, and titled “Real Time Remote Video Collaboration,” which is a continuation of U.S. patent application Ser. No. 16/794,962, filed Feb. 19, 2020, and titled “Real Time Remote Video Collaboration,” the contents of each of which are herein incorporated by reference in their entirety.

### BACKGROUND

The process of creating motion picture and television entertainment is complex and contains many logistical barriers. Productions often involve widely spread locations for filming. Even if productions are filmed in a single location, the post-production tasks involving editing, computer graphics, scoring, sound, color, and review invariably require people in different locations to either meet together or to collaborate remotely. Many of the costs and delays inherent in media production are barriers of time and space.

The result of this is that telepresence tools are more needed than ever to overcome barriers of time and space inherent in production. The challenge of past audio conferencing, video conferencing, and online video collaboration tools is that they are a poor substitute for being physically present. There are various deficiencies in traditional tools used for video conferencing. Cost and complexity are major issues, with many systems requiring expensive hardware installations of cameras and screens and configuration of network environments to support necessary bandwidth.

In addition, both software-based and hardware-based video transmissions systems have latency (delay) and quality issues. Delay manifests in network delays and compression delays that make transmissions not feel instant, with delays exceeding half of a second to more than a second.

There are other problems inherent in remote collaboration. Many media productions have high security requirements due to the amount of investment at stake. Only authorized, trustworthy personnel should be allowed to collaborate on a project, but remote collaboration makes physical enforcement of security (locked doors, physical access controls) impossible.

### BRIEF DESCRIPTION OF THE DRAWINGS

FIG. 1 is an example environment for remote video collaboration, in accordance with implementations of the present disclosure.

FIG. 2 is a transition diagram of color calibrating client devices at different locations for remote video collaboration, in accordance with implementations of the present disclosure.

FIGS. 3A through 3B are a transition diagram for continuous security verification of participants at different locations accessing a real time communication system for remote video collaboration, in accordance with implementations of the present disclosure.

FIGS. 4A through 4B are a transition diagram of real time remote video collaboration, in accordance with implementations of the present disclosure.

FIGS. 5A through 5B are a transition diagram of another real time remote video collaboration, in accordance with implementations of the present disclosure.

FIG. 6 is a flow diagram of an example client device color adjustment process, in accordance with implementations of the present disclosure.

FIG. 7 is a flow diagram of an example user identity verification process, in accordance with implementations of the present disclosure.

FIG. 8 is a flow diagram of an example real time communication video collaboration process, in accordance with implementations of the present disclosure.

FIG. 9 is a flow diagram of another example real time communication video collaboration process, in accordance with implementations of the present disclosure.

FIGS. 10A through 10G are transition diagrams for remote folder sharing during a real time communication session and video based access authentication, in accordance with implementations of the present disclosure.

FIG. 11 is an example remote folder process, in accordance with implementations of the present disclosure.

FIG. 12 is an example side communication process, in accordance with implementations of the present disclosure.

FIG. 13 is an example real time communication session RTC room access process, in accordance with implementations of the present disclosure.

FIGS. 14A through 14B is an example secure file access process, in accordance with implementations of the present disclosure.

FIG. 15 is an example real time communication session process, in accordance with implementations of the present disclosure.

FIG. 16 is an example real time communication session review process, in accordance with implementations of the present disclosure.

FIG. 17 is a block diagram of computing components that may be utilized with implementations of the present disclosure.

### DETAILED DESCRIPTION

As is set forth in greater detail below, implementations of the present disclosure are directed toward real time communication (“RTC”) sessions that allow secure collaboration with respect to video for editing and movie production, for example, in which participants may each be at distinct and separate locations. Collaboration between participants to perform video editing for movie production requires low latency and high quality video exchange between client locations, as well as a secure environment. As discussed further below, client devices may interact with an RTC management system to obtain color calibration information so that the color presented on the different client devices is consistent with each other and corresponds to the intended color of the video for which collaboration is to be performed. Matching color between different locations allows the preservation of the creative intent of content creators. In addition, the disclosed implementations enable an on-going multifactor authentication for each participant to ensure that the participant remains at the client location and viewing the video presented on the client device. Still further, to improve the quality of the exchanged video information and to reduce transmission requirements, in response to detection of events, such as a pause event, a high resolution image of a paused video may be generated and sent for presentation on the display of each client device, instead of continuing to stream a paused video.

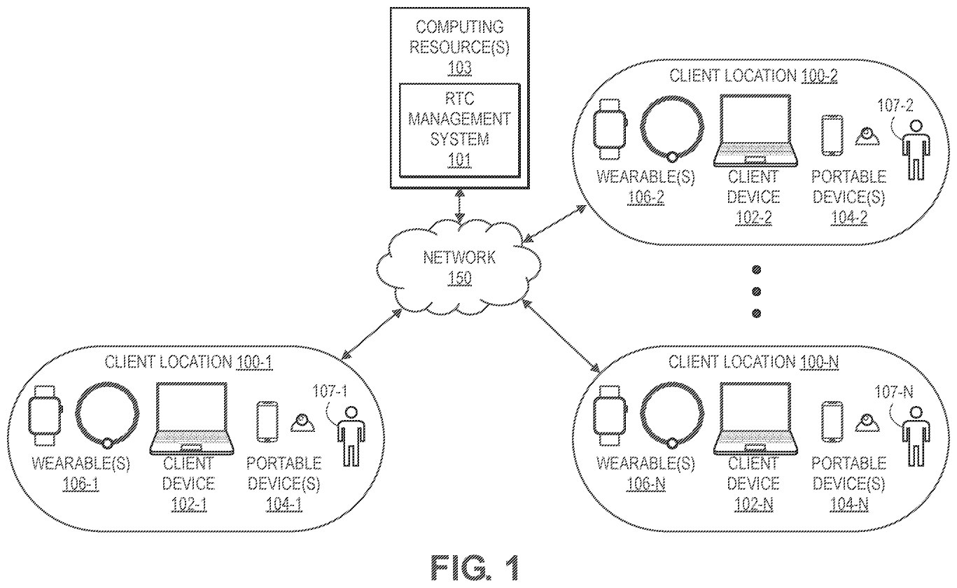

FIG. 1 is an example environment for remote video collaboration, in accordance with implementations of the present disclosure.

As illustrated, any number of client locations, such as client locations 100-1, 100-2, through 100-N may communicate and interact with one another and/or a real time communication (“RTC”) management system 101 executing on one or more remote computing resources 103. Each of the client locations 100 and the RTC management system 101 may communicate via a network 150, such as the Internet.

Each client location 100 may include a client device 102, one or more portable devices 104 that are owned, controlled, and/or operated by a participant 107, and/or one or more wearable devices 106 that are owned, controlled, and/or operated by the participant 107. A client device 102, as used herein, is any type of computing system or component that may communicate and/or interact with other devices (e.g., other client devices, portables devices, wearables, RTC management system, etc.) and may include a laptop, desktop, etc. A portable device 104, as used herein, includes any type of device that is typically carried or in the possession of a user. For example, a portable device 104 may include a cellular phone, or smartphone, a tablet, a laptop, a web-camera, a digital camera, etc. A wearable device 106, as used herein, is any type of device that is typically carried or worn by a user and may include, but is not limited to, a watch, necklace, ring, etc.

In the illustrated example, client location 100-1 includes a client device 102-1, one or more portable devices 104-1, one or more wearable devices 106-1, and a participant 107-1. Likewise, client location 100-2 includes a client device 102-2, one or more portable devices 104-2, one or more wearable devises 106-2, and a participant 107-2. Any number of client locations 100-N with participants 107-N may be utilized with the disclosed implementations, and each client location may include a client device 102-N, one or more portable devices 104-N, and one or more wearable devices 106-N.

As discussed further below, each client device 102 may be used by a respective participant to access the RTC management system and collaborate on one or more videos exchanged via the RTC management system. Likewise, as discussed further below, portable devices 104 and/or wearable devices 106 may communicate with each other and/or the respective client device 102 and provide ongoing or periodic user identity verification, referred to herein as identity information, to the RTC management system 101. For example, a portable device 104 may wirelessly communicate with the client device using a short wave communication system, such as Bluetooth or Near Field Communication (“NFC”), thereby confirming the presence of the portable device with respect to the location of the client device. Likewise, one or both of the portable devices 104 and the wearable devices 106 may likewise provide position information regarding the position of the portable device 104/wearable device 106 and such information may be used by the RTC management system 101 to verify the location of the participant. Still further, one or more of the client device 102, portable device 104, and/or the wearable 106 may provide image data of the participant and/or the area immediately surrounding the participant. Again, such information may be processed to determine the location of the participant, the identity of the participant, and/or whether other individuals at the location may pose a security breach threat.

Still further, as discussed below, the client devices 102 enable participants at each location to collaborate on a video that is streamed or otherwise presented by one of the client devices 102 or the RTC management system 101. As is typical during video collaboration, one participant will request to have the video paused, referred to herein as a trigger event. Upon detection of the trigger event, rather than continue to stream the paused video from one client device to others, a high resolution image, such as an uncompressed image, of the paused video may be obtained or generated and sent to destination client devices and presented on the display of those devices instead of, or over, the paused video. Such an implementation provides a higher resolution image of the video and reduces the transmission demands between client devices and/or the RTC management system. When the video is resumed, another trigger event, the high resolution image is removed from display, and presentation of the streamed video resumes on each of the client devices.

In some implementations, the RTC management system may be streaming a video file and be aware of the current frame of the file that is being streamed and on which frame the visual display is paused. Upon receiving a trigger event, the system may generate and send a high resolution image of the current frame as well as frames before and after the current frame. For example, using the trigger event as an indication of a region of interest in the file, the system may generate and send a defined number of high resolution images (first plurality of high resolution images) generated from frames preceding. By providing a defined number of frames before and after the current frame, if a client desires to navigate forward or backwards several frames, the high-resolution frames are available for presentation. Similarly, if the client plays a clip containing the paused frame, the clip will be able to be played back at high resolution using at least all of the frames that have been sent in high resolution. The system can continue to download high-resolution frames to the client around the region of interest as long as the file is paused.

As is known, the Rec. 709 color space, which is commonly used in HDTV, has an expanded range of colors that can be represented, and the Rec. 2020 color space, which is commonly used for Ultra HD, includes an even broader range of colors that it can represent. The wider the color space, the more colors that can be represented, and the larger the amount of data it requires to represent them. In the disclosed implementations, more bits may be used for each color channel. For example, rather than an 8 bit RGB color channel, the disclosed implementations may utilize 10 bits or 12 bits per channel to represent the red, green and blue components of a pixel. These higher bit per channel allocations can be used to represent so called “high dynamic range” (HDR) content for displays capable of reproducing it.

In some implementations, a user at a device may interact with a color space selection dialog to select one of many different display profiles to be used. The display profiles may provide a color look-up table that translates or maps colors from a device independent color space, to the monitor that is being used to view the image, and does the best job it can to accurately represent the intended colors. The better the color reproduction range of the target monitor, the higher the fidelity of the mapping between the source image and the image space. The full range of human color perception can be represented in a device independent color space such as that specified in ACES 1.0 (Academy Color Encoding System) developed by the Academy of Motion Picture Arts and Sciences.

In the process of authoring high resolution, high-dynamic range, deep color content, it is often desirable for users in different locations to have a reference so that they agree on what they are viewing. As a result, users may use color-calibrated monitors of the same manufacturer and/or that are capable of accurately representing the same color space. Thus, if two production personnel at a distance from each other are working in an agreed-upon color space, say, P3, they could transmit images in P3 across a distance and reproduce them at both ends. Alternatively, they could represent the P3 image in the Rec. 2020 color space (of which P3 is a subset) and transmit in Rec. 2020 as the agreed upon reference space, then view the image on an appropriate, agreed upon reference display.

An issue that comes up in sharing content at a distance is that the content is often compressed. In addition to spatial and temporal compression that reduces size and removes information based on changes, another common approach to compressing images is to subsample portions of the image chroma, i.e. allocating more resolution to the luminance portion of an image (in the green spectrum) and lower resolution to the blue and red channels. So-called “4:2:2” sub-sampling allocates half the pixel resolution to red and blue. In comparison, 4:4:4, with no sub-sampling, performs no sub-sampling on pixels.

In order to preserve the maximum amount of visual quality, color precision, and color range in an image, it is preferable to convey image data using as little lossy image compression as possible, ideally none (i.e., a raw image).

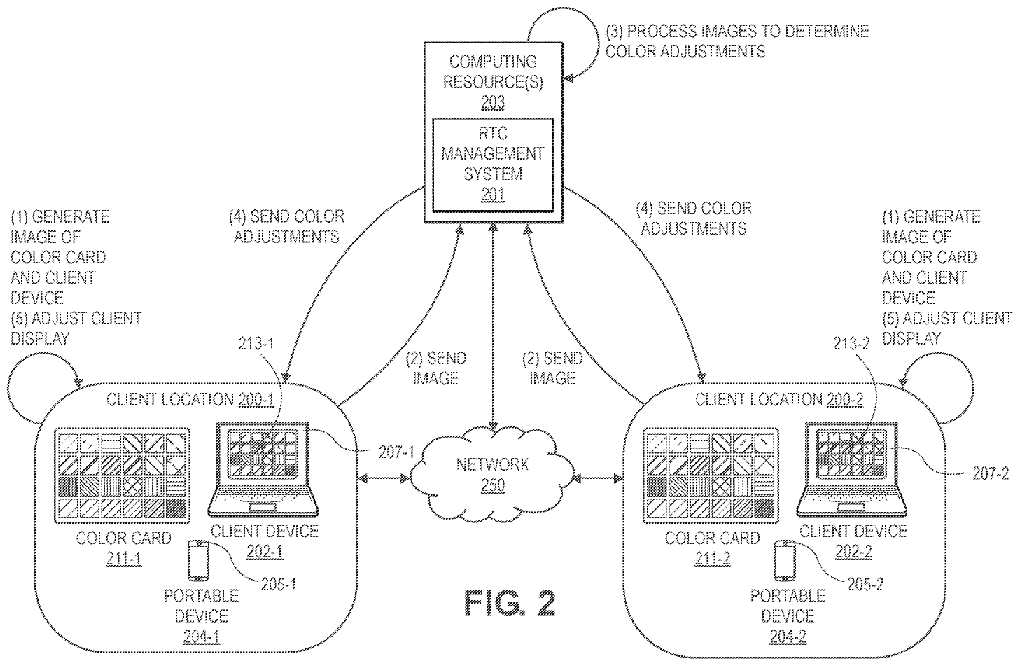

FIG. 2 is a transition diagram of color calibrating client devices 202 at different client locations 200 for remote video collaboration, in accordance with implementations of the present disclosure. To enable consistent and accurate color presentation of video between each client device 202 at the different client locations, such as client location 200-1 and 200-2, a physical color card, such as color cards 211-1 and 211-2 may be held up next to a display 207-1/207-2 of the client device 202-1/202-2 that is presenting a series of color bars 213-1/213-2 and an image of the color card 211-1/211-2 and the display 207-1/207-2 with the presented color bars 213-1/213-2 generated by a camera 205-1/205-2 or other imaging element of a portable device 204-1/204-2. For example, the image(s) may be sent from each client location 200-1/200-2 to the RTC management system 201 executing on one or more computing resources 203, via the network 250, such as the Internet.

The RTC management system 201, upon receiving the image(s) from the portable devices 204, may process each image to determine differences between the color card 211 and the color bars 213 represented in the images. For example, an image received from portable device 204-1 may be processed to determine a difference in the color of the color card 211-1 and the color bars 213-1 presented on the display 207-1 of the client device 202-1, as represented in the image. Likewise, an image received from portable device 204-2 may be processed to determine a difference in the color of the color card 211-2 and the color bars 213-2 presented on the display 207-2 of the client device 202-2, as represented in the image. The color card, when captured by the camera of the mobile device, is compared to a reference image and used to create a lighting profile that can be used to compensate for any lighting conditions and determine the range of values that can be accurately captured using that particular camera. In addition, the same camera may be used to capture an image of color bars being rendered on the screen, in the same lighting conditions (but using projected, not reflected light as with the card). The RTC management system 201 can then use the awareness of the capabilities of the camera to know how the camera alters the colors, to compensate for or cancel out any fidelity issues introduced by the camera and/or the lighting conditions.

The color card 211 may be a passive, physical card, such as a matte or glossy printed medium. The color card may take various forms and include paint, dye, etc., superimposed on a porous surface such as paper or cardboard. The color card may be coated with a matte or reflective coating. In some implementations, the color card may be passive, non-powered card that produces a reflective color response, providing information about the ambient light the space near the screen. Alternately, the color card may be in the form of a translucent image such as a ‘gel,’ with a backlight. A translucent backlit card allows for transmissive color which may be more representative of the transmissive color of a display, such as an LED or OLED display. In still other examples, the color card may be a digital image projected on a device such as a tablet or smartphone.

In some implementations, processing of the image may result in a gamma adjustment instruction that is provided to the client device 202 to adjust the gamma of the display 207 of the client device 202 so that the color bars 213 presented by the display 207 correspond to the colors of the color card 211. For example, the image received from the portable device 204-1 at the client location 200-1 may be processed to determine a first gamma adjustment instruction, and that first gamma adjustment instruction may be sent from the RTC management system 201 to the client device 202-1 to instruct the client device 202-1 to adjust a gamma of the display 207-1. Likewise, the image received from the portable device 204-2 at the client location 200-2 may be processed to determine a second gamma adjustment instruction, and that second gamma adjustment instruction may be sent from the RTC management system 201 to the client device 202-2 to instruct the client device 202-2 to adjust a gamma of the display 207-2. These processes may be performed numerous times for each client device 202 at each client location until the color bars presented on the display of each client device 202 correspond to the colors of the respective color cards 211.

In some implementations, to obtain consistency between client devices at different locations, in addition or as an alternative to adjusting the display of each client device 202 so that the color bars presented on the display 207 of the device correspond to the colors of the respective color card 211, the RTC management system 201 may also compare the color bars presented on the displays of the different client devices to determine color differences between those client devices. For example, after adjusting the gamma of client device 202-1 and the gamma of client device 202-2 so that the color bars of those client devices correspond as closely as possible to the colors of the color cards 211-1 and 211-2, the RTC management system may compare the color bars presented by each client device 202-1 and 202-2 to determine any differences between the presented colors of those devices. If a difference is determined, one or both of the client devices may be instructed to further adjust the gamma of the display 207 until the color bars 213-1/213-2 presented on the displays 207-1/207-2 are correlated.

As will be appreciated, the color adjustment between color cards and color bars, as discussed herein, may be performed for a single device communicating with the RTC management system or for any number of client devices communicating with the RTC management system. Likewise, while the above example discusses the RTC management system 201 executing on the computing resources 203 receiving images from portable devices 204 at the various client locations and processing those images to determine gamma adjustment instructions, in other implementations, the images may be processed by the portable device 204 that generated the image and the portable device 204 may determine and provide the gamma adjustment instruction to the client device 202. In still other examples, the portable device 204, upon generating the image of the color card 211 and the color bars 213 presented on a display 207 of the client device 202, may provide the image to the client device 202, and the client device 202 may process the image to determine gamma adjustment instructions. In addition, there may be other adjustment parameters besides gamma that improve the color fidelity, and the system may provide adjustment instructions for other adjustable parameters of the client device configuration such as color depth, color lookup table, resolution, subsampling frequency, brightness, saturation, hue, white point, dynamic range, etc.

In some implementations, to obtain consistency between client devices at different locations, in addition or as an alternative to adjusting the display of each client device 202, the two ends will use an identically configured portable device 204 on either end, where the portable devices automatically adjust their own gamma, brightness or other parameters. The portable devices may then use an “augmented reality” approach using an integrated camera to capture and identify the image that is being displayed on the client device, and then connect to the RTC management system 201 to retrieve the same image that is being shown on the client devices 202-1 and 202-2. Each portable device 204 renders a portion of the image being viewed on the client device 202, much like a “magnifying glass.” A user can “pinch/zoom” the image on the portable device. The portable devices, being of the same manufacture, often have smaller screens for displaying high resolution images using display technologies e.g. Organic LED (OLED), and have higher dynamic range using display features such as High Dynamic Range (HDR). For instance, both ends may have different kinds of displays on client devices 202, but have the same model of modern smartphones as portable devices 204. Thus, the smartphones may operate as an auto-calibrating, consistent color-reproducing system on both ends of a remote connection, and display a portion of the image corresponding to what is being pointed to on the client devices 202.

In some implementations, the mobile device may also perform the same manual calibration steps using color bars and/or color cards as are used for the client devices. The mobile device may also use a forward facing camera (also known as a “selfie” camera) to measure ambient light and correspondingly adjust the brightness and color of the image on the screen to produce color calibration reference values that result in the same color settings on both ends of a conference.

In some examples, a “blue filter” technique may be utilized for calibration. In such examples, the disclosed implementations may display color bars and then disable the other color channels on the system at the operating system level, or by communicating with the monitor. An external blue filter may be placed between a camera of the portable device 204 and the corresponding client device 202, and the portable device 204 (or the client device 202) may instruct the user to adjust brightness and contrast until the bars presented on the display match. In this way, some of the subjectivity or human error may be eliminated. The portable device 204 may also use its own internal ability to filter only the blue color channel from the images captured, and then instruct the user to adjust brightness and contrast until it is in the correct position for optimal color matching.

In some examples, the portable device 204 may run an application that communicates with an application running on the client device 202 being calibrated, which in turn sends commands to the operating system or attached monitor to automatically adjust the brightness and contrast using a digital interface, until any of the color matching techniques described above are calibrated correctly. Alternately, or in addition thereto, the portable device 204 may provide instructions to the user to accomplish the same. Alternately, the portable device 204 may instruct the software on the client device 202 to programmatically select a different color space or color configuration automatically.

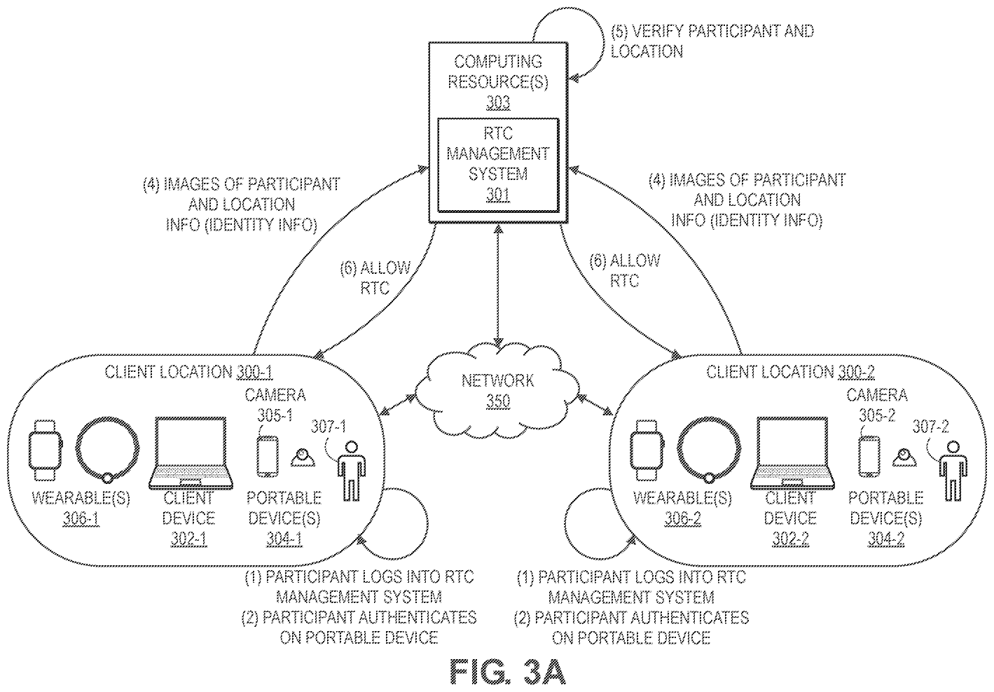

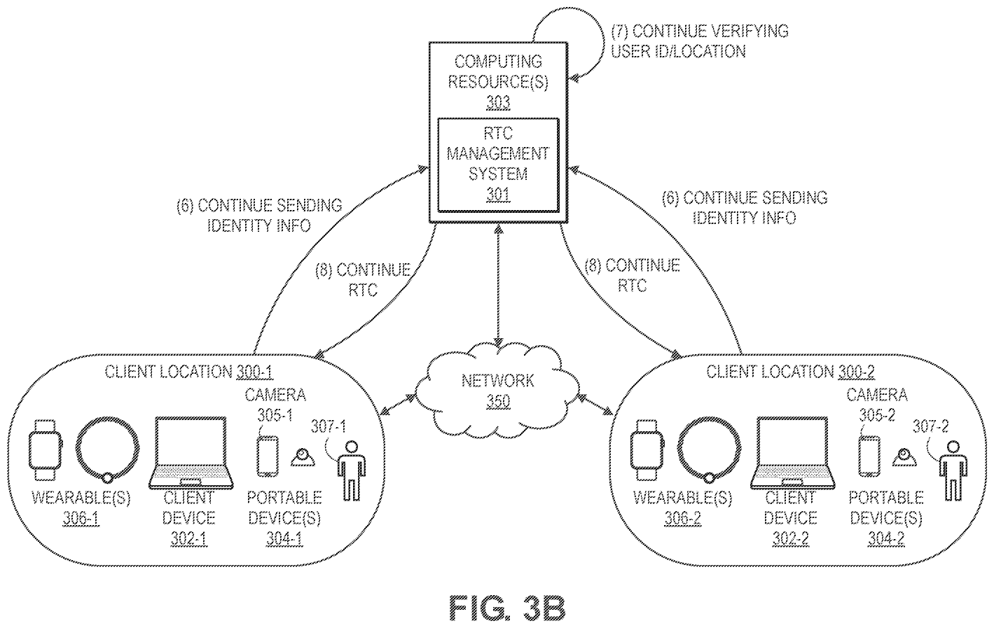

FIGS. 3A through 3B are a transition diagram for on-going security verification of participants 307 at different client locations 300 accessing a real time communication system 301 for remote video collaboration, in accordance with implementations of the present disclosure. The illustrated example is discussed with respect to two client locations 300-1 and 300-2. However, it will be appreciated that any number of client locations may be included in the RTC communication session and on-going security verification performed at each of those locations.

As discussed, the on-going security utilizes multifactor authentication and multiple devices to continually or periodically verify participants of an RTC management system 301. In the illustrated example, a participant 307-1/307-2 accesses and logs into, via a client device 302-1/302-2, at respective client locations 300-1/300-2 the RTC management system 301, which may be executing on one or more computing resources 303. Any form of authentication, such as a username and password, pass phrase, biometric security, USB YubiKey, or other technique may be utilized to enable access or logging into the RTC management system 301 by a participant.

In addition to a participant logging into the RTC management system 301 using a client device 302-1/302-2, the user may also self-authenticate on a portable device 304-1/304-2 that is in the possession of the participant and local to the client device 302-1/302-2 used by the participant to log into the RTC management system 301. Self-authentication on the portable device 304-1/304-2 may be performed using any one or more self-authentication protocols that are native to the portable device, such as facial recognition, fingerprint or other biometric verification, passcode, etc.

Upon self-authentication, the portable device 304 and the client device 302 may be linked, for example using a short-distance wireless communication link such as Bluetooth, NFC, etc. For example, the participant may launch or otherwise execute an application stored in a memory of the portable device and the application may establish a communication link with an application executing on the client device 302. During the RTC session, the application executing on the client device 302 may periodically or continuously poll or obtain information (such as keepalives or cryptographic handshakes) from the application executing on the portable device 304 to verify that the portable device is within a defined distance or range of the client device 302.

In addition, as part of RTC communication session establishment and ongoing verification, an image of the participant may be generated by a camera 305-1/305-2 of the portable device 304-1/304-2 and sent to client device 302-1/302-2 and/or the RTC management system 301. The image may be processed to verify the identity of the participant represented in the image, to confirm that the participant is within the defined distance of the client device, and/or to confirm that there are no other individuals within a field of view of the camera of the portable device 304-1/304-2. In addition, location information obtained from one or more location determining elements, such as a Global Positioning Satellite (“GPS”) receiver, of the portable device 304-1/304-2 may also be utilized to verify the location of the participant. Image data, location data, and/or other information corresponding to or used to verify the identity and/or location of a participant is referred to herein as identity information.

At initiation and during an RTC session, identity information of the participant may be provided to verify the location and identity of the participant. Once verified, the RTC session is established or allowed to continue between the RTC management system 301 and the client device 302. If, however, the location of the portable device moves beyond a defined distance of a location of the client device 302 and/or the identity of the participant cannot be verified from the identity information, the RTC session is terminated for the client device 302.

In still other examples, the identity information may be further processed to determine whether any other individuals are present at the client device 302. If any other individuals are present, that are not also participants, the RTC management session with the client device 302 is terminated.

In some implementations, as still another form of verification, position information and/or movement data from one or more wearable devices 306 may also be included in the identity information and utilized to verify the location and/or identity of the participant 307. For example, location information obtained from a wearable of the participant may be utilized as another verification point. In other examples, movement data, heart rate, blood pressure, temperature, etc., may be utilized as another input to verify the location, presence, and/or identity of the participant 307.

As illustrated in FIG. 3B, once the RTC session is established, identity information continues to be sent on a continuous or periodic basis from one or more of the client device 302, portable devices(s) 304, and/or wearable(s) 306 and processed by the RTC management system 301 to continue verifying the identity and location of the participant 307 and either continuing to enable the RTC session or terminating the RTC session. For example, one or more of the client device 302-1, portable device(s) 304-1, and/or wearable(s) 306-1 may continuously or periodically send identity information corresponding to the participant 307-1 at client location 300-1 and the RTC management system 301 executing on the computing resource(s) 303 may process the identity information to verify the identity and location of the participant 307-1 so that the RTC session between the RTC management system 301 and the client device 302-1 may continue. Likewise, one or more of the client device 302-2, portable device(s) 304-2, and/or wearable(s) 306-2 may continuously or periodically send identity information corresponding to the participant 307-2 at client location 300-2 and the RTC management system 301, executing on the computing resource(s) 303 may process the identity information to verify the identity and location of the participant 307-2 so that the RTC session between the RTC management system 301 and the client device 302-2 may continue. If the identity information cannot be verified between either the client location 300-1 and/or the client location 300-2, the RTC session with that location is terminated, thereby maintaining security between the RTC management system 301 and the other client locations.

In some implementations, the disclosed implementations may also be utilized to verify the identity and location of a participant accessing the RTC management system 301 such that recorded or stored video data can be provided to the participant for viewing. For example, an editor may generate a segment of a video and indicate that the segment of video is to be viewed by a producer. That segment of video and the intended recipient may be maintained by the RTC management system 301. At some later point in time, when the producer accesses the RTC management system 301 using a client device 302, portable device 304 and/or wearable 306, as discussed above, such that the identity and location of the producer is verified, the RTC management system 301 may allow access to the segment of video by the producer and continually verify the identity and location of the producer as the producer is viewing the segment of content.

In still other examples, upon authentication of the user via the client device to access the RTC management system, an application executing on the client device may monitor for unauthorized activity and prohibit that activity from occurring. For example, the RTC management system may specify that client devices in an RTC session cannot record the session or record what is presented on the display of the client device, etc. During the session, the application monitors the client device for any such activity and prohibits the activity from occurring. In other examples, if the activity is attempted, the application executing on the client device may prohibit the activity and send a notification to the RTC management system. The RTC management system, upon receiving the notification may terminate the RTC session with that client device and/or perform other actions.

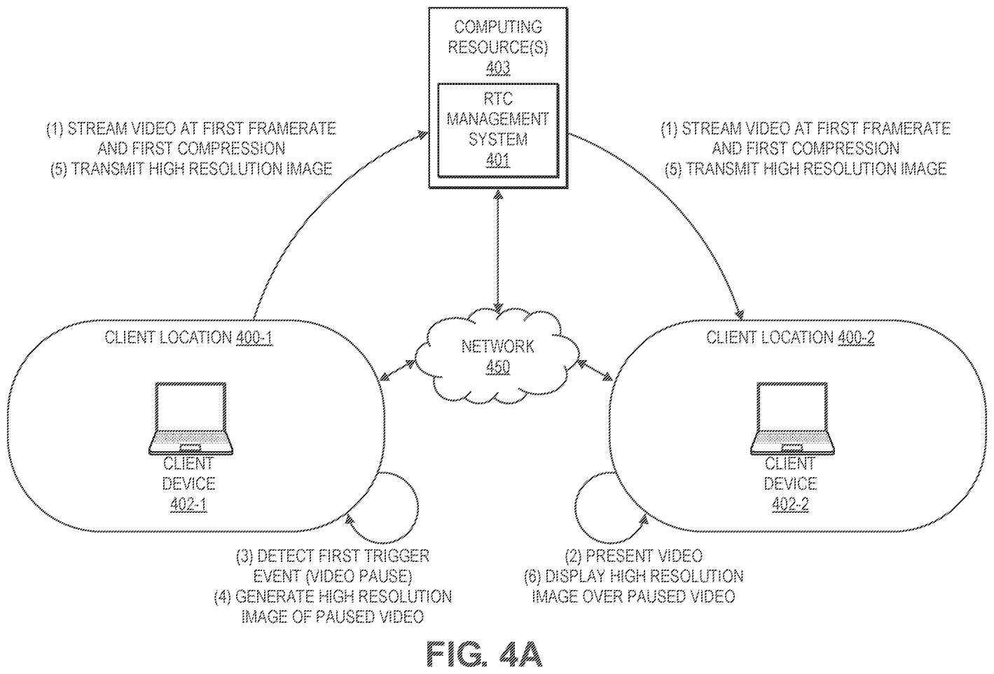

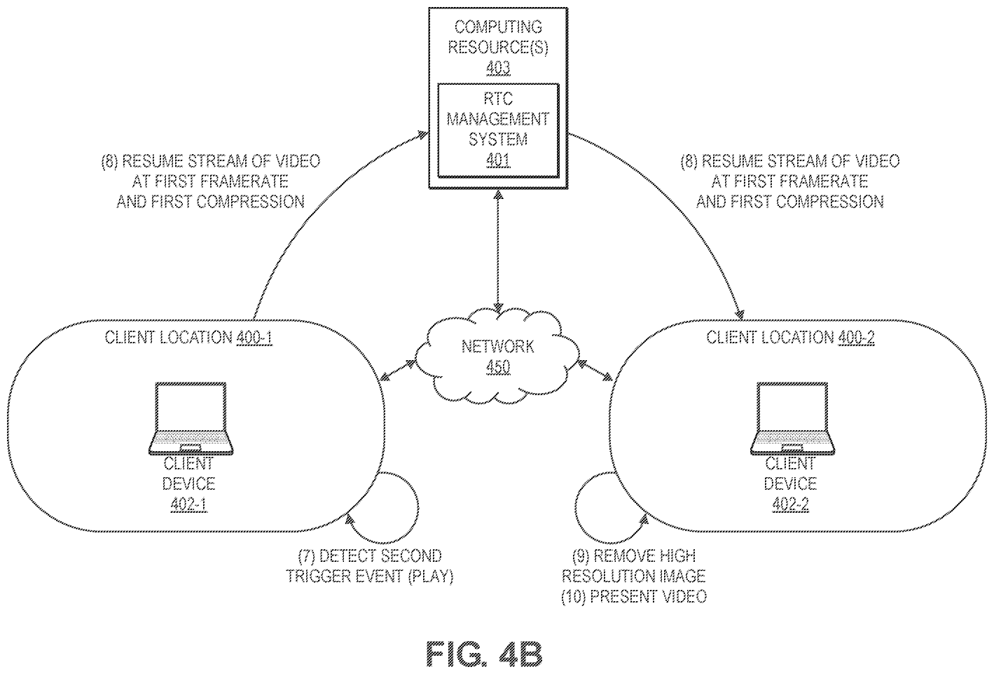

FIGS. 4A through 4B are a transition diagram of real time remote video collaboration, in accordance with implementations of the present disclosure. The example transition discussed with respect to FIGS. 4A through 4B may be performed during any RTC session and/or other exchange between two or more client devices 402 and/or an RTC management system 401 executing on the computing resources 403. Likewise, while the example discussed with respect to FIGS. 4A through 4B describe real time remote video collaboration between two client devices 402-1, 402-2 at different client locations 400-1 and 400-2 and via a network 450, it will be appreciated that any number of client devices 402 and client locations 400 may be included and utilized with the disclosed implementations.

In the discussed example, client device 402-1 is streaming a video, such as a pre-release movie production video, from client device 402-1, referred to herein as a source device, to client device 402-2, referred to herein as a destination device. As is known in the art, existing systems allow the remote collaboration or sharing of video from one device to another using, for example, webRTC. For example, during movie production, an editor at a source client device 402-1 may remotely connect with a producer at a destination client device 402-2 and the editor may stream video segments at a first framerate and first compression using a first video channel between the source client device and the destination client device, for review and collaboration with the producer. The client device 402-1 may be running streamer software, standalone or embedded into a web browser. This streamer software may stream a file directly, may stream video captured from an external capture device connected to a video source, or may stream a live capture of a screen, a portion of a screen, or a window of a running application on the screen.

As is typical during these collaborations, the producer and/or the editor may request or cause the video to be paused at a particular point in the video, referred to herein as a trigger event. For example, the producer my tell the editor to pause the video. While the video is paused, the producer and editor may collaborate and discuss the video, present visual illustrations on the paused video, which may be transmitted via a second video channel and presented as overlays on the streaming video, etc. In existing systems, the webRTC session continues to stream the paused video using the first video channel and at the same framerate and compression, even though the video is paused and not changing.

In comparison, with the disclosed implementations, upon detection of a trigger event, such as a pause of the video, as illustrated in FIG. 4A, a high resolution image of the paused video is generated at the source client device 402-1 and sent from the source client device 402-1 to the destination client device 402-2 and the streaming of the video at the framerate and compression is terminated. For example, a high resolution screen shot of the display of the paused video on the display of the source client device 402-1 may be obtained as the high resolution image. In another example, an application executing on the source client device may communicate with a video player or editor application on the source client device 402-1 that is streaming the video and the video player or editor application may generate and provide a high resolution image of the paused instance of the video. In some implementations, the high resolution image may be an uncompressed or raw image of a frame of the video presented on the display when the video is paused.

Continuing with the example, the high resolution image is sent from the source client device 402-1 to the destination client device 402-2, for example through the RTC management system 401 executing on computing resource(s) 403, thereby maintaining security of the RTC session, as discussed above, and the destination client device 402-2, or an application executing thereon, may present the high resolution image on the display of the client device, rather than presenting the paused video. As a result, the participant, such as the producer, is presented with a high resolution image of the paused video, rather than the compressed image included in the video stream. In addition, the continuous streaming of the video at the first framerate and first compression is eliminated, thereby freeing up computing and network capacity. The participants may then collaborate on the high resolution image as if it were the paused video, for exampling discussing and/or visually annotating the high resolution image.

Referring now to FIG. 4B, if a second trigger event is detected, such as a playing of the video, the source client device 402-1 resumes streaming of the video at the first framerate and first compression. Likewise, the destination client device 402-2, upon receiving the resumed video stream, removes the high resolution image from the display of the destination client device 402-2 and resumes presentation of the resumed video stream as it is received.

As will be appreciated, the exchange between streaming video and presentation of a high resolution image may be performed at each trigger event, such as pause/play event and may occur several times during an RTC session.

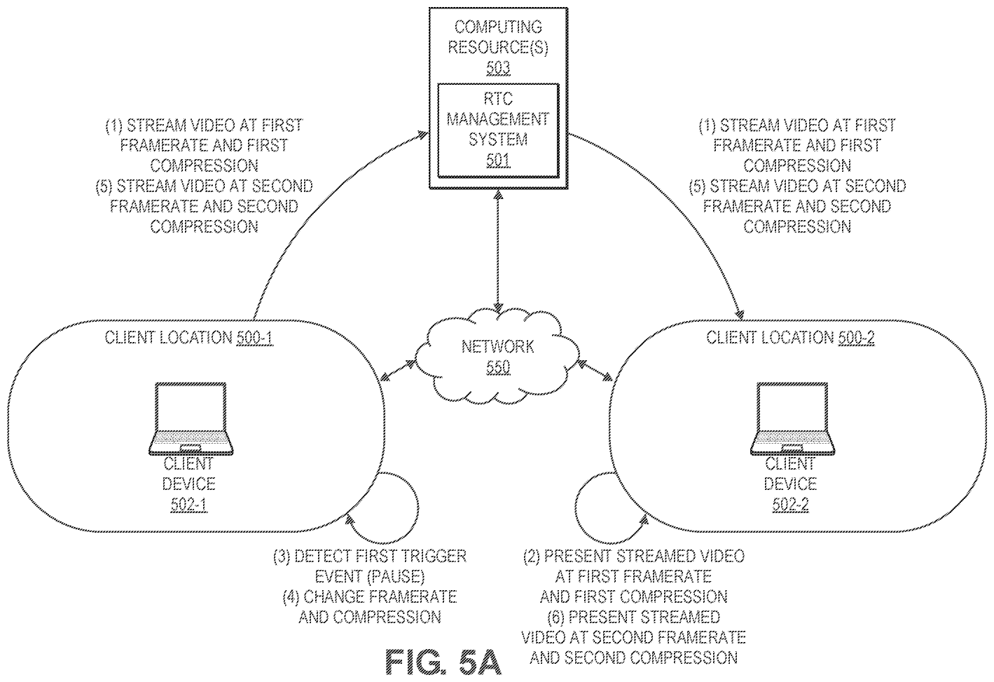

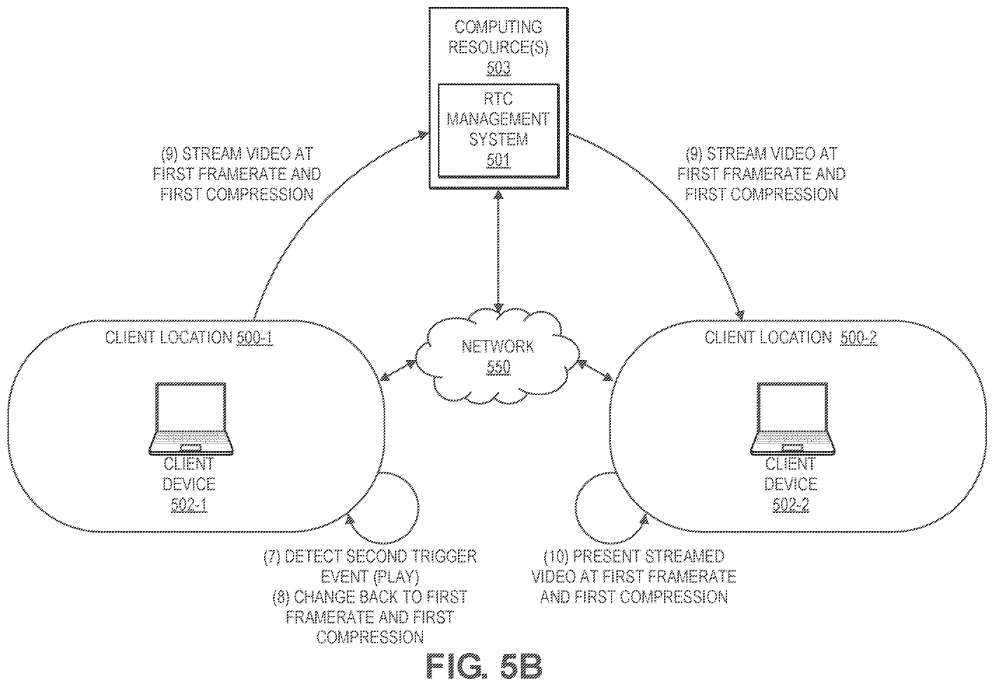

FIGS. 5A through 5B are a transition diagram of another real time remote video collaboration, in accordance with implementations of the present disclosure. The example transition discussed with respect to FIGS. 5A through 5B may be performed during any RTC session and/or other exchange between two or more client devices 502 and/or an RTC management system 501. Likewise, while the example discussed with respect to FIGS. 5A through 5B describe real time remote video collaboration between two client devices 502-1, 502-2 at different client locations 500-1 and 500-2, it will be appreciated that any number of client devices 502 and client locations 500 may be included and utilized with the disclosed implementations.

In the discussed example, client device 502-1 is streaming a video, such as a pre-release movie production video, from client device 502-1, referred to herein as a source device, to client device 502-2, referred to herein as a destination device. As is known in the art, existing systems allow the remote collaboration or sharing of video from one device to another using, for example, webRTC. For example, during movie production, an editor at a source client device 502-1 may remotely connect with a producer at a destination client device 502-2 and the editor may stream video segments at a first framerate and first compression using a first video channel between the source client device and the destination client device, for review and collaboration with the producer. For example, the first framerate may be twenty-four frames per second and the first codec may be for example, H.265, H.264, MPEG4, VP9, AV1, etc.

As is typical during these collaborations, the producer and/or the editor may request or cause the video to be paused at a particular point in the video (trigger event). For example, the producer my tell the editor to pause the video. While the video is paused, the producer and editor may collaborate and discuss the video, present visual annotations on the paused video, which may be transmitted via a second video channel and presented as overlays on the streaming video, etc. In existing systems, the webRTC session continues to stream the paused video using the first video channel and at the first framerate and using the first compression, even though the video is paused and not changing.

In comparison, with the disclosed implementations, upon detection of a trigger event, such as a pause of the video, as illustrated in FIG. 5A, the streaming video may be changed to a second framerate and second codec with a different compression and the paused video streamed at the second framerate and second compression while paused. For example, the second framerate may be lower than the first framerate and the second compression may be lower than then first compression. In some implementations, the second compression may be no compression such that the video is streamed uncompressed at the second framerate, which may be a very low framerate. For example, the second framerate may be five frames per second. Lowering the framerate and the compression results in a higher resolution presentation of the paused video at the destination device. As discussed above, altering the framerate and compression is in response to a trigger event. In such an instance, the available bandwidth may remain unchanged.

Continuing with the example, the lower framerate and lower compression video is streamed from the source client device 502-1 to the destination client device 502-2, for example through the RTC management system 501 executing on computing resource(s) 503, thereby maintaining security of the RTC session, as discussed above, the destination client device 502-2, or an application executing thereon, upon receiving the streamed video, may present the streamed video on the display of the destination client device. In such an implementation, the destination client device need not be aware of any change and simply continues to present the streamed video as it is received. Because the video has a lower compression, the participant, such as the producer, is presented with a higher resolution presentation of the paused video. In addition, because the video is paused and not changing, the lower framerate does not cause buffering and/or other negative effects. The participants may collaborate on the higher resolution streamed video, for exampling discussing and/or visually annotating the high resolution image.

Referring now to FIG. 5B, if a second trigger event is detected, such as a playing of the video, the source client device 502-1 resumes streaming of the video at the first framerate and first compression. Because the video has been continuously streamed, although at a lower framerate and lower compression while paused, the destination client device may just continue presenting the streamed video as it is received.

As will be appreciated, the exchange between streaming video at the first framerate and first compressions and streaming video at the second framerate and second compressions may be performed at each trigger event, such as pause/play event and may occur several times during an RTC session.

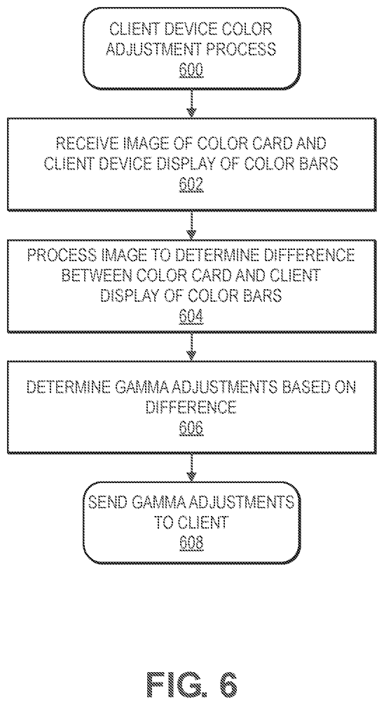

FIG. 6 is a flow diagram of an example client device color adjustment process 600, in accordance with implementations of the present disclosure. The example process 600 begins upon receipt of an image that includes a representation of a color card, as discussed above, and a presentation of color bars on a display of a client device, as in 602. For example, as discussed above, a participant may hold a color card up next to a display of a client device and generate an image using a portable device, the image including the color card and the display of the client device, upon which color bars are presented.

Upon receipt of the image, the image is processed to determine differences between the colors presented on the color card and the colors of the color bars presented on the display of the client device, as in 604. For example, one or more color matching algorithms may be utilized to compare colors of the color card and the color bars presented on the display of the client device to determine differences therebetween. The receiving application may isolate out a specific color channel, such as blue, and detect differences between the received blue-channel images. The receiving application may compare ambient light in the front-facing camera with the color bar and card information received from the rear facing camera. The processing algorithm may run on a similar device on both ends, such as a particular model of smartphone with an identical camera system, and thus provide a fairly standardized comparative of both the color calibration of the screen and the colors it displays given the lighting conditions of the environments on both ends. The receiving application may communicate with the device being calibrated, causing it to alter the color bars or other information being shown (color bars can include any desired image for calibration) and alter the colors, the color profile of the device, or the brightness or contrast or other picture settings of the attached monitor, or indicate to the user to alter any of the above settings manually. The receiving device may manipulate the color settings displayed on the device being calibrated to show a changing range of colors so that a full range can be tested by both ends, and may instruct a user to bring the receiving device closer to or farther away from the screen to adjust the ambient light such as by turning off lights in the RTC room, turning them on, closing or opening the blinds, and so on.

Based on the determined difference, a gamma adjustment instruction for the client device is generated, as in 606. As is known in the art, the gamma of a display controls the overall brightness of an image. Gamma represents a relationship between a brightness of a pixel as it appears on a display, and the numerical value of the pixel. By adjusting the gamma of the display, the difference between the color bars presented on the display and the color card may be decreased. Accordingly, the gamma adjustment instruction is sent to the client device for adjustment of the gamma of the display of the client device, as in 608.

As noted above, the example process 600 may be performed numerous times until the difference between the color card and the color bars presented on the display of the client device is negligible or below a defined threshold. The threshold may vary depending upon, for example, the display capabilities of the display of the client device, the video to be streamed, etc.

In some implementations, instead of or in addition to adjusting the gamma based on the color cards, the color bars presented on displays of multiple different client devices may also be compared and gamma adjustment instructions generated and sent to those client devices to adjust those devices so the color bars presented on the displays of those client devices are correlated.

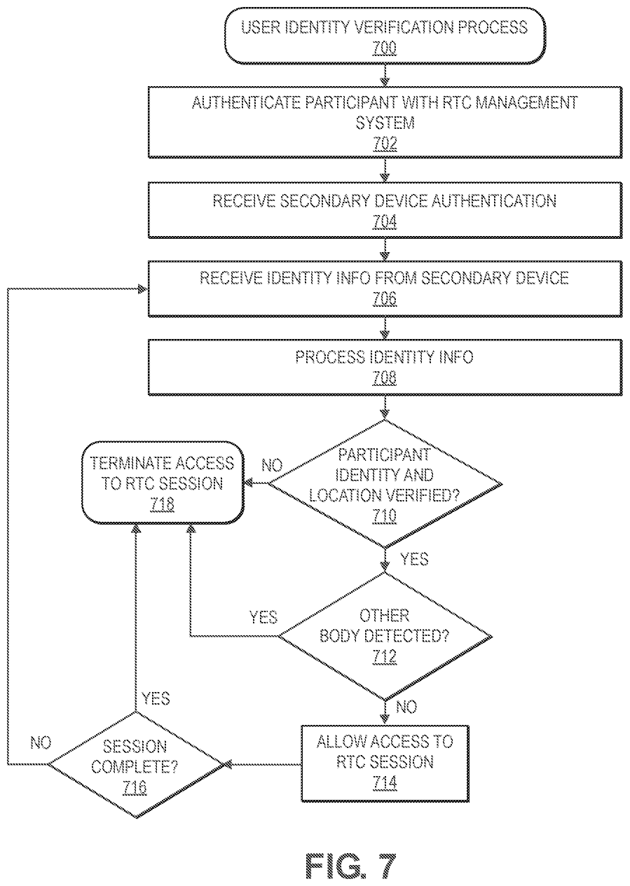

FIG. 7 is a flow diagram of an example user identity verification process 700, in accordance with implementations of the present disclosure. The example process 700 may be performed at all times during an RTC session and separately for each participant of the RTC session to continuously or periodically verify the identity of users participating in the RTC session, thereby ensuring the security of the RTC session.

The example process 700 begins when a participant authenticates with the RTC management system, as in 702. For example, a participant, using a client device, may log into the RTC management system by providing a username and password and/or other forms of verification.

In addition to the participant directly authenticating with the RTC management system, the example process receives a secondary device authentication, as in 704. The secondary device authentication may be received from any secondary device, such as a portable device, a wearable device, etc. Likewise, the secondary authentication may be any authentication technique performed by the secondary device and/or an application executing on the secondary device to verify the identity of the participant.

Once the participant has self-authenticated with the RTC management system and secondary authorization has been received, identity information corresponding to the participant may also be received from the secondary device, as in 706. Identity information may include, but is not limited to, location information corresponding to the location of the secondary device and/or the client device, which may be in wireless communication with the secondary device, user biometric information (e.g., heartrate, blood pressure, temperate, etc.), user movement data, images of the user, etc.

In some implementations, system may store the biometrics image of a person that it has not identified, but has been allowed into an RTC management system conference RTC room by another authorized user. Subsequently, the system may re-identify the same individual using the stored biometrics. The system will create an identity record with metadata of this identified, anonymous, authenticated but unidentified user. They system may also track, for this unidentified user, any time that the user accesses the system and is allowed into the system, so that if the user is later identified, the earlier accesses are matched to the user. This helps preserve an audit trail in the event assets are accessed and later the persons who accessed them need to be identified.

As the identity information is received, the example process 700 processes the received identity information to verify both the location of the participant and the identity of the participant, as in 708. For example, a location of the client device engaged in the RTC session may be determined during initial authentication or via information obtained from the portable device. Likewise, location information from the portable device may be obtained to verify that the portable device has not moved more than a defined distance (e.g. five feet) from the location of the client device. Likewise, identity information generated by the portable device may also be processed to verify that the participant remains with the portable device and thus, the client device.

If it is determined that the identity and location of the participant are verified, as in decision block 710, a determination is made as to whether another body or individual is detected in the identity information, as in 712. For example, if the identity information includes image data of the participant, the image data may be further processed to determine if any other individuals, other than the participant, are represented in the image data. As another example, a motion detection element, such as infra-red scanner, SONAR (Sound Navigation and Ranging, etc.) of the portable device and/or the client device may generate ranging data and that data may be included in the identity information and used to determine if other people are present. If it is determined that no other bodies or individuals are detected, access to the RTC session by the client device is established or maintained, as in 714.

In comparison, if it is determined that either the identity of the user or the location of the user is not verified at decision block 710 and/or that another body or individual is detected in the identity information, at decision block 712, access to the RTC session by the client device is denied or terminated, as in 718.

Finally, the example process 700 also determines if the RTC session has completed, as in 716. If it is determined that the RTC session has not completed, the example process 700 returns to block 706 and continues. If it is determined that the RTC session has completed, access to the RTC session is terminated, as in 718.

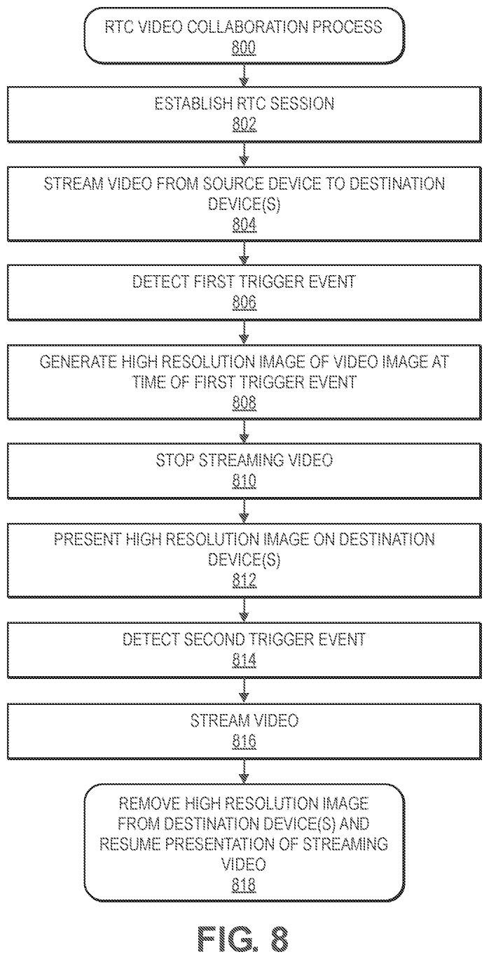

FIG. 8 is a flow diagram of an example real time communication video collaboration process 800, in accordance with implementations of the present disclosure.

The example process 800 begins upon establishment of an RTC session, as in 802. Upon initiation of the RTC session, video is streamed at a first framerate (e.g. 25 frames per second) and a first compression from a source client device to one or more destination client devices, as in 804.

At some point during the RTC session a first trigger event, such as a pause of the streamed video, is detected, as in 806. For example, an editor at the source client device may pause the streamed video. As another example, a participant at one of the destination client devices may cause the streamed video to be paused.

Upon detection of the trigger event, a high resolution image of the paused video is generated at the time of the first trigger event, as in 808. For example, a full resolution screenshot of the display of the source client device that includes the paused video may be generated as the high resolution image. As another example, an application executing on the source client device that is presenting the streaming video, may generate a high resolution image of the video when paused.

In addition, streaming of the now paused video is terminated, as in 810, and the high resolution image is sent from the source client device to the destination client device(s) and presented on the display of the destination client device(s) as an overlay or in place of the terminated streaming video, as in 812. As discussed above, participants of the RTC session may continue to collaborate and discuss the video and the high resolution image provides each participant a higher resolution representation of the paused point of the video.

At some point during the RTC session a second trigger event, such as a play or resume playing of the video is detected, as in 814. For example, a participant at the source client device may resume playing of the video at the source client device. As another example, a participant at one of the destination client devices may cause the video to resume playing.

Regardless of the source of the second trigger event, streaming of the video from the source client device at the first framerate and first compression is resumed, as in 816. Likewise, the high resolution image is removed from the display of the destination client device(s) and the resumed streaming video is presented on those displays, as in 818.

As will be appreciated, the example process 800 may be performed several times during an RTC session, for example, each time a trigger event is detected.

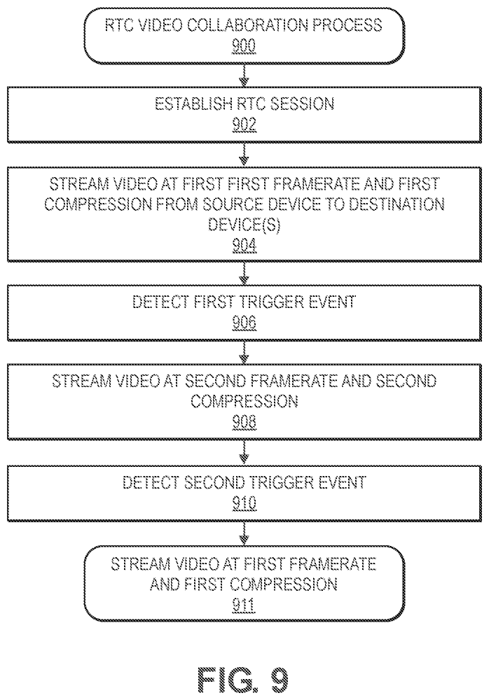

FIG. 9 is a flow diagram of another example real time communication video collaboration process 900, in accordance with implementations of the present disclosure.

The example process 900 begins upon establishment of an RTC session, as in 902. Upon initiation of the RTC session, video is streamed at a first framerate (e.g. 25 frames per second) and a first compression from a source client device to one or more destination client devices, as in 904.

At some point during the RTC session a first trigger event, such as a pause of the streamed video, is detected, as in 906. For example, an editor at the source client device may pause the streamed video. As another example, a participant at one of the destination devices may cause the streamed video to be paused.

Upon detection of the trigger event, the framerate and compression of the streaming video is changed to a second framerate and second compression, as in 908. For example, the second framerate may be lower than the first framerate (e.g., five frames per second) and the second compression may be less than the first compression (e.g., no compression). As a result, the streaming of the video continues, but at a higher resolution while paused. As discussed above, participants of the RTC session may continue to collaborate and discuss the video and the high resolution streamed video provides each participant a higher resolution representation of the video while it is paused.

At some point during the RTC session a second trigger event, such as a play or resume playing of the video is detected, as in 910. For example, a participant at the source client device may resume playing of the video at the source client device. As another example, a participant at one of the destination client devices may cause the video to resume playing.

In response to the second trigger event, streaming of the video at the first framerate and the first compression is resumed, as in 911.

As will be appreciated, the example process 900 may be performed several times during an RTC session, for example, each time a trigger event is detected. Likewise, the example processes 800/900 may be performed at any network bandwidth that supports video streaming and the bandwidth may remain substantially unchanged during the RTC session. Still further, any one or more CODECs (e.g., AV1, H.265, MPEG4, etc.) may be used to compress the video to the first compression and/or the second compression. Still further, while the above example references the video being streamed from a source client device, in other implementations, the video may be streamed from the RTC management system to one or more destination client devices. In such an example, upon detection of a trigger event, the RTC management system may pause the streaming video, generate and send a high resolution image to the one or more client devices. Alternatively, the RTC management system may alter the video stream from a first framerate and first compression to a second framerate and second compression that are different than the first framerate and first compression, as discussed above. Alternatively, the RTC management system may deliver an uncompressed or losslessly compressed or raw version of the video stream or a portion of the video stream around a region of interest indicated by the trigger event.

In addition to the above implementations, users can direct the RTC management system to an online content management system or cloud storage system, using an API. The disclosed implementations can connect to, say, DROPBOX, AMAZON WEB SERVICES, MICROSOFT AZURE, etc. The cloud service can be simple storage or a more complex content management service. The RTC management system can navigate through a list of files and view metadata about them, as well as streaming them, collaboratively share them, etc. For example, the disclosed implementations, may transform files from an original format (not using the cloud storage's streamer, but controlling and transcoding the file). Alternately, the disclosed implementations may access or log into the cloud storage system and allow users to share files from that system.

Without limitation, the disclosed implementations may also be applied to other media asset managers as well. For example, users can embed another content management system in the RTC management system such as ADOBE PIX SYSTEM or FRAME.IO and the user can run the respective web page, but the web page is rendered remotely on the RTC management system and then streamed to all clients.

In still other examples, an RTC application may execute on a client device which re-encodes screen grabs or files for real-time streaming to the RTC management system. As discussed further below, the files reside and remain on the client device and the RTC application executing on that client device may direct streaming software to a folder on that client device. The streaming software connects to the RTC management system and provides a list of all the files accessible on the client device to the RTC management system. The RTC management system enables other client devices to view and access those other files stored in memory of other client devices, as well as interact with the file stored on those other client devices.

For example, a user at one client device can request to preview a file that is physically stored on another client device. Previewing the file creates a dynamic live streaming session from the streaming software, up to the RTC room RTC management system, and back down to the requesting client device and any other client devices accessing the RTC room (discussed below). The play, pause, rewind, fast forward, etc., commands are controlled by viewers in the RTC room, remotely. In this way, any client device accessing the RTC room can navigate, with no delay, and preview large numbers of remote files as if those files were on their own machine. Thus, a content library containing any number of files can be effectively instantly shared and only the metadata about the files (filename, size, when created, thumbnails, etc.) needs to be uploaded. This metadata can be streamed up as well so that over time the entire library of metadata is more fully provided.

The file streamer software may be remote controlled by the participants of the RTC room, from each individual client device. Such a configuration is secure in that it only shares the folder that has been designated by the person running the streamer. The file streamer shares all files within the designated folder and subfolders, and only the types of files designated are shared. Each client device can designate one or many folders and/or files. Likewise, the RTC management system software can be run as an operating system “service” so that it continuously operates. In addition, the RTC management system may monitor the current bandwidth to the RTC room and each client device and automatically calibrate the preview and/or streaming resolution so that the streamed content fits in real-time within available bandwidth.

Multiple participants can independently share their content libraries to the same RTC room. For example, three different cinematographers can have their dailies or ongoing work automatically provided to the RTC room.

Embedded versions of the disclosed implementations can be installed on software running in hardware that runs on network attached storage devices. For example, the software can be embedded in a device that acts as a normal hard drive, but has WI-FI access and connects to a network. Thus, it can provide continuous access to the files that have been recorded by a camera. For instance, a camera may have a multi-terabyte solid state drive onto which it records 8K footage. The streaming software runs on the camera or on the solid state hard drive and provides a list and metadata of all files (including the current file being recorded) so that file indicators can be generated and presented in the RTC room. A client device connected to the RTC room can preview any of the files, including the file currently being written to the camera, allowing for close to real-time monitoring of any of the currently running cameras. When hard drives are removed or cycled off of a camera and plugged into, for example, a powered backup system, they will continue to provide previews to the RTC room for the files stored in memory. Software can be additionally configured to upload a re-encoded version of the dailies/files to the RTC room so that they are available when the hard drives or cameras go off-line. Accordingly, as discussed herein, files stored on a hard drive of a camera are effectively treated as files stored in a memory of a client device (the camera) that is part of the RTC session/RTC room.

The client application can also integrate the ability not only to provide files to stream into an RTC room, but can provide video conferencing as well. For instance, the client application may be implemented as a plug-in that goes into a video editing or creative suite application such as ADOBE PREMIERE, AVID, or FINAL CUT PRO. The client application may be configured to connect to the API provided by these programs to access the media content stored and edited within these applications. For instance, the currently open media project under edit within a video editing application, which is made up of numerous other multimedia files and settings, may be presented as a single “file” to the client application for preview, even though it has not been “flattened” or exported into a single file.

The client application, operating as a plugin, provides an appropriate, live-streamable version that fits within available bandwidth, to provide a real-time preview of the content being edited, but showing only the content and not the play/pause controls or other media controls. Alternately, the client application, operating as a plugin, may provide a full display of a selected subset of media edit controls. For example, the client application, operating as a plugin, may export fine grained controls remotely so that other participants of the RTC room can manipulate the controls of the edit suite application, such as scrubbing (Fine grained seeking through frames, such as with a dial wheel control), color adjustments, or any other feature within the application that is desired to be manipulated remotely.

The video conferencing can be integrated into the application as a plugin, so for instance, such that additional windows are displayed outside of or within the main application that show other participants in the RTC room.

In some implementations, the client application may operate as a file streamer application that may exist on a client device and/or may be hosted in the cloud. The file streamer may be directed to other sources of cloud assets and/or any other online medium such as DROPBOX, AMAZON WEB SERVICES, MICROSOFT AZURE, etc. Using the APIs of such systems, the file steamer may provide a list of the files stored in these locations and their associated metadata to the RTC room. When selected, the streamer retrieves and transcodes a version of the media stored on the RTC management system into an appropriate format for real-time streaming to the RTC room and other participants.

In some implementations, other media asset manager software such as CMS (content management systems) can be embedded directly into an RTC room. Since the RTC room is hosted in the cloud (such as on AMAZON WEB SERVICES), the streamer software can run directly in the RTC room, accessing the APIs of other streaming services. In some implementations, the RTC room can run an instance of a web browser, and access cloud services for sharing by directly rendering a web page in the cloud, then rendering remotely on the RTC management system and then streaming to all client devices access the RTC room.

In some implementations, image recognition may be used on the image of a user requesting access to an RTC room to determine preliminarily if they were already in the RTC management system. If the user is known to the RTC management system and associated with the RTC room to which they are requesting access, the user might be let into the RTC room. Alternately, the user might have their image shown to the user(s) in the RTC room who are capable of/authorized to grant/deny the user access to the RTC room. The users would see the image of the requesting client device user and determine if that user is allowed into the RTC room. In some implementations, the RTC management system may audit user granted accesses by recording the user to which access was provided, the user who authorized the access, and/or a bit of video before and/or after granting of access, and send this session to an archive relating to security. In some implementations, a Machine learning algorithm may be trained to look for anomalies or nonstandard accesses to RTC rooms. For example, was a user aware they were letting someone into the RTC room, did the user visually verify the requesting user before granting access, did the granting user seem to recognize the requesting user before granting access, etc. The RTC management system may allow a requesting user to access the RTC room but it may then email or otherwise send images of the requesting and/or granting user to a supervisor for automatic review of whether they should have access to the RTC room. In such an example, access may be temporary and the requesting user may need to be granted access each time.

In some implementations, a user who has access to an RTC room may invite another user or client device into the RTC room and that invited user or client device may be granted access. In such an example, the RTC management system might note that although the invited user is not in a biometric database of the RTC management system, and has not been added as an authorized user, the invited user may have been previously invited.

In some implementations, there can be a situation where there is no user in the RTC room that is authorized to allow a requesting user to access the RTC room. In this case, access by a guest may be unavailable. However, in other implementations, the live video from the requesting client device could go out to an RTC room organizer who was not in the RTC room at that time, and the RTC room organizer could review the video feed and grant or deny access. In that way a RTC room can be created by an RTC room organizer and then various users can be allowed into the RTC room without requiring the RTC room organizer to also be in the RTC room.

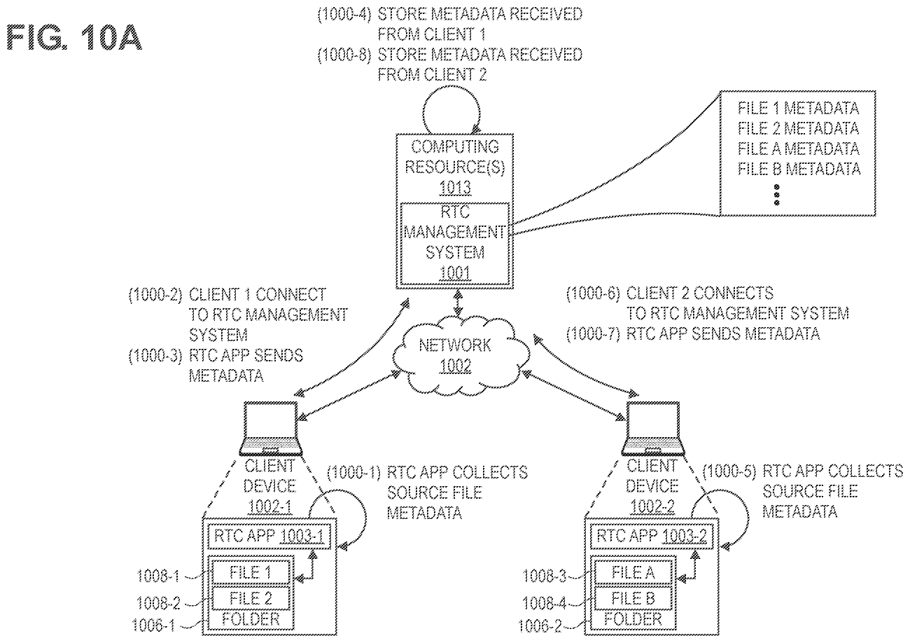

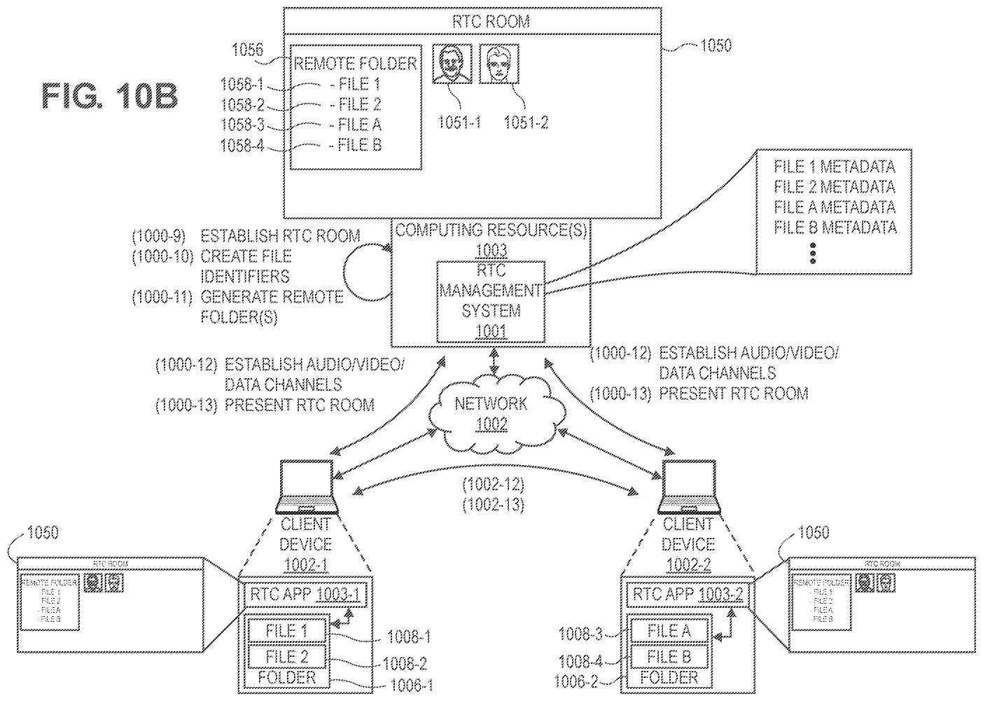

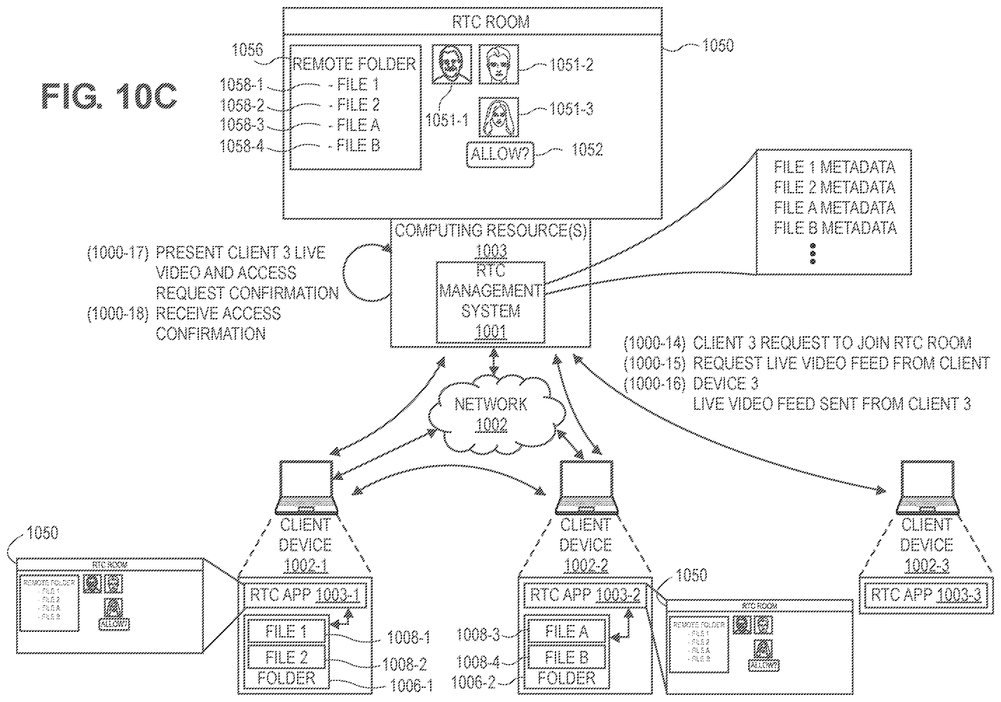

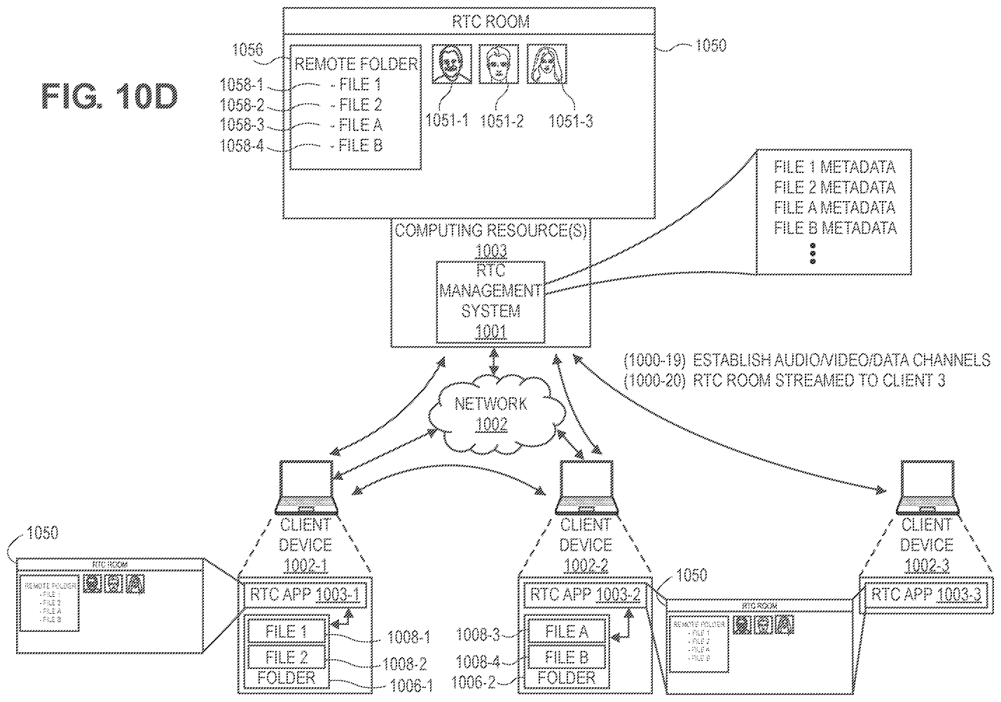

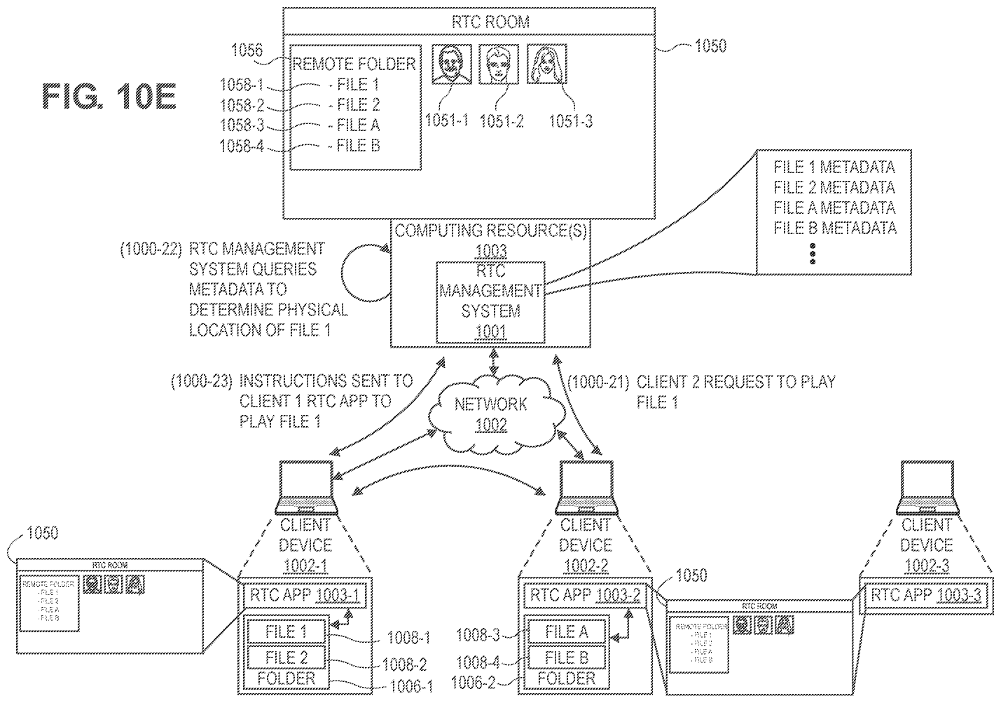

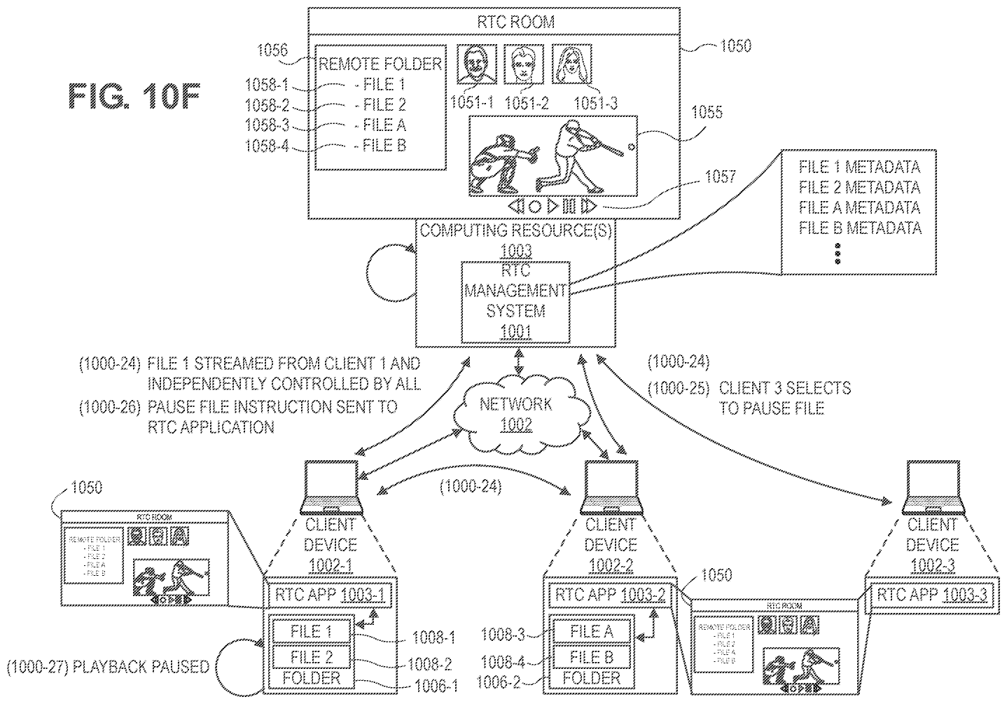

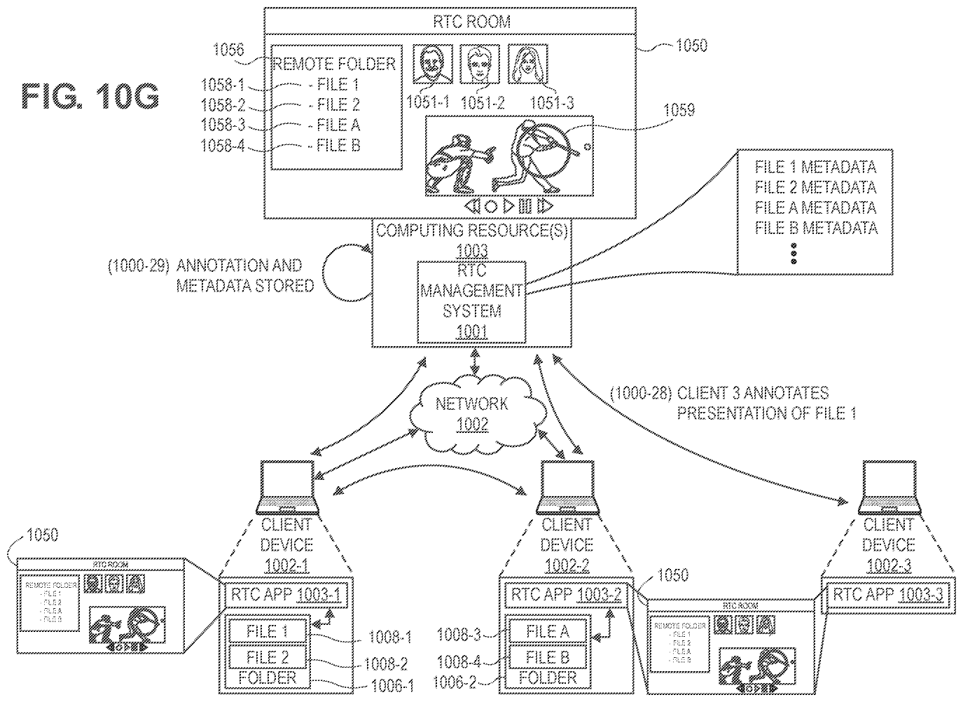

FIGS. 10A through 10G are transition diagrams for remote folder sharing during an RTC session and video based access authentication, in accordance with implementations of the present disclosure.

As illustrated in this example, an RTC application 1003-1 executing on a first client device 1002-1 queries a memory section, referred to herein as a folder 1006-1, of memory of the first client device 1002-1, to obtain metadata about files stored in the folder 1006-1, as in 1000-1. For example, a user of the first client device 1002-1 may identify a folder 1006-1 that is accessible to the RTC application 1003-1. The RTC application 1003-1 may periodically access the identified folder 1006-1 and obtain metadata for any files contained or stored in that folder 1006-1. In this example, file 1 1008-1 and file 2 1008-2 are stored in the folder 1006-1 of the first client device 1002-1 that is linked to or accessible by the RTC application 1003-1 executing on the client device.

As metadata is identified by the RTC application 1003-1, the RTC application 1003-1 and first client device 1002-1 connect, via a network 1002, to RTC management system 1001 executing on the remote computing resources 1013, as in 1000-2. Once connected, the RTC application sends the metadata for each of the files stored in the folder 1006-1 of the first client device 1002-1, as in 1000-3. In the illustrated example, the RTC application 1003-1 sends metadata for each of file 1 1008-1 and file 2 1008-2 from the first client device 1002-1 to the RTC management system 1001. The file metadata may include, among other information, the physical location of the file on the first client device 1002-1, an identifier of the file, a type of the file, a size of the file, a length of the file, and/or other information. Notably, as discussed further below, the actual file, such as file 1 1008-1 and file 2 1008-2 remain stored on the client device and are not transferred from the client device to the remote computing resources 1013.

As the RTC management system 1001 receives metadata about files stored on client devices, such as client device 1 1002-1, the metadata is stored in a memory of the computing resources 1013, as in 1000-4.

In this example, in addition to the RTC application 1003-1 executing on the first client device 1002-1 sending in metadata for files stored in the memory of the first client device 1002-1 that are accessible to the RTC application 1003-1, a second RTC application 1003-2 executing on a second client device 1002-2 also collects metadata about files stored in a memory of the second client device 1002-2 that are accessible to the second RTC application 1003-2, as in 1000-5. In this example, the second RTC application 1003-2 has access to file A 1008-3 and file B 1008-4 that are stored in a folder 1006-2 to which the RTC application 1003-2 has access.

As the second RTC application collects metadata about files stored in the memory of the second client device 1002-2, the RTC application connects to the RTC management system, as in 1000-6, and provides the metadata about those files to the RTC management system, as in 1000-7. As the metadata is received from the second client device 1002-2, the RTC management system 1001 stores the received metadata in a memory of the remote computing resources 1013, as in 1000-8. In some implementations, the metadata received from both the first client device 1002-1 and the second client device 1002-2 may be stored in a same memory segment of the remote computing resources 1013. In other implementations, the metadata received from the different client devices may be stored in different memory sections of the remote computing resources.

As noted above, in accordance with the disclosed implementations, only the metadata is transferred from the client devices to the RTC management system executing on the remote computing resources 1013, thereby allowing the security of the actual files to remain under the control of the respective client device.

Referring now to FIG. 10B, at some point, an RTC room 1050 may be created for real-time collaboration between the first client device 1002-1 and the second client device 1002-2, as in 1000-9. In this example, the RTC room 1050 is generated and concurrently presented on each client device 1002-1, 1002-2 as if the RTC room were local on each separate client device.

An RTC room, as used herein, is a virtual area that may be established for any period of time and used to facilitate and/or support one or more RTC sessions. For example, the RTC room may be used to associate metadata, file indicators, indicate users/participants and/or client devices allowed to access the RTC room or an RTC session associated with an RTC room, etc. Additionally, while the disclosed examples primarily reference between two and three client devices and corresponding participants, an RTC room and/or RTC session may include fewer or additional clients devices and/or participants. Likewise, the disclosed implementations are not limited to client devices accessing an RTC room and/or RTC session. Any of the devices discussed herein may be associated with and/or used with an RTC room and/or RTC session.

As part of that RTC room creation, or at any time when metadata about a file is sent from any client device that is participating in or connected to the RTC room 1050, each item of received metadata may be used to create a file indicator representative of the respective file stored on the different client devices. The file indicator may be representative of the file, but not actually include the file, and selectable by any client device participating in the RTC room 1050 as if the file indicator were actually the file and included in the RTC room 1050. In this example, file 1 1008-1 stored on the first client device 1002-1 is represented by a file 1 identifier 1058-1, file 2 1008-2 stored on the first client device 1002-1 is represented by a file 2 identifier 1058-2, file A 1008-3 stored on the second client device 1002-2 is represented by a file A identifier 1058-3, and file B 1008-4 stored on the second client device 1002-2 is represented by a file B identifier 1058-4.

In addition, a remote folder 1056 may be generated and the file indicators 1058 of the different files stored on the different client devices may be consolidated into the remote folder for presentation to each client device participating in the RTC room 1050 as if the files were actually stored in the remote folder 1056, as in 1000-11. In other implementations, multiple different remote folders 1056 may be created and the different file indicators stored in different folders, again as if the files were actually stored on the remote computing system and part of the RTC room 1050.

As part of the RTC room creation, RTC channels, such as an audio channel, video channel, and/or data channel may be established between each of the first client device 1002-1, the second client device 1002-2, and the RTC management system 1001, as in 1002-12, thereby starting an RTC session between the client devices and the RTC management session. In this example, the RTC session is associated with the RTC room. Finally, the RTC room, as part of the RTC session, may be presented on each of the client devices 1002-1, 1002-2 included as part of the RTC room, as in 1000-13. In the illustrated example, the RTC room 1050 may have a variety of information presented on or in the RTC room. In this example, in addition to the remote folder 1056 and file indicators 1058, a live video feed 1051-1 of a first user using the first client device 1002-1 and a live video feed 1051-2 of a second user using the second client device 1002-2 may also be transmitted between the devices and presented in the RTC room 1050 as part of the RTC session. As illustrated in FIG. 10B, each client device 1002-1, 1002-2 may be presented with an RTC room 1050 that is identical. In other implementations, the video feed of the client device on which the RTC room is presented may be omitted from the RTC room 1050. For example, the RTC room 1050, as presented on the first client device 1002-1, may, in some implementations, omit the first video feed 1051-1 and the RTC room 1050, as presented on the second client device 1002-2, may omit the second video feed 1051-2.

Referring now to FIG. 10C, in this example, at some point during the RTC session, a third client device 1002-3 may submit a request to join the RTC room 1050, as in 1000-14. Rather than require the user of the third client device to remember and provide a password or other access identifier, in the disclosed implementations, the RTC management system 1001, in response to receiving the access request, may require or request a live video feed from a camera of the third client device 1002-3 be transmitted as part of the access request, as in 1000-15. For example, the RTC management system 1001 may send a response to the RTC application 1003-3 executing on the third client device 1002-3 and request that RTC application 1003-3 activate the camera of the third client device 1002-3 and send live video obtained from the camera of the third client device to the RTC management system 1001, as in 1000-16.

The RTC management system 1001, upon receipt of the live video feed from the third client device, may present the live video feed 1051-3 to one of the other client devices and/or to all other client devices that are included in the RTC session, along with a request 1052 that confirmation be provided to allow the third client device to join the RTC session, as in 1000-17. In some implementations, the live video feed may only be sent to one of the client devices included in the RTC session, such as a client device identified as a moderator or leader of the RTC session, also referred to herein as an RTC room organizer.

Providing a live video feed from the camera of the requesting client device not only simplifies the access process for the user at the requesting client device (i.e., the user does not have to recall or provide a password or other identifier) but it also enhances the overall security of the RTC room. Specifically, presenting a live video feed from the requesting client device allows a user participating in the RTC session to visually verify the user that is requesting access.

In the illustrated example, an access confirmation to allow the third client device to join the RTC session is received, as in 1000-18. In response to the access acknowledgement, referring to FIG. 10D, one or more of an audio channel, video channel, and/or data channel may be established between each of the first client device 1002-1, the second client device 1002-2, the third client device 1002-3, and the RTC management system 1001, as in 1000-19 and the RTC room 1050 is streamed to the third client device 1002-3, as in 1000-20. In addition, in this example a third live video stream 1051-3 of the user at the third client device 1002-3 is presented as part of the RTC room 1050 to each of the other client devices/participants participating in the RTC session. Still further, in this example, the RTC application 1003-3 does not have access to a file of the third client device and/or files stored on the third client device and therefore, no metadata for files stored on the third client device is sent to the RTC management system. Regardless, because the third client device 1002-3 is now participating in the RTC session and viewing the RTC room 1050, the third client device 1002-3 can view each file indicator 1058 and the remote folder 1056 as if the files represented by those file indicators were included in the RTC room 1050.

While the discussed example indicates that each client device included in the RTC room can view and access all file indicators, in some implementations, an RTC room organizer may specify which file indicators and/or remote folders 1056 can be accessed and viewed by different client devices of the RTC room. For example, the first client device 1002-1 may be indicated as the RTC room organizer and may determine, as the organizer, that second client device 1002-2 can view and access each of the file indicators 1058 but that the third client device 1002-3 can only view and access file 1 identifier 1058-1. In other examples, other access privileges may be specified.

During an RTC session, any client device participating in the RTC session that is allowed to access a file indicator may select that file indicator. For example, and referring to FIG. 10E, in this example, the second client device 1002-2 submits a request to play file 1, represented by file 1 identifier 1058-1 presented on the remote folder 1056 of the RTC room 1050, as in 1000-21. A request to access, or in this example, play a file may be any of a variety of access requests. For example, the second client device 1002-2 may, using an input-output component of the client device, such as a mouse, keyboard, trackpad, touch-based display, etc., may select the file indicator 1058 and that selection may be indicative of an access request with respect to that file, such as a request to play the file.

The RTC management system, upon receipt of the access request from the second client device with respect to file 1, represented by the file 1 identifier 1058-1, queries the metadata stored for the RTC room to determine the physical location of file 1 1008-1 represented by the selected file 1 identifier 1058-1, as in 1000-22. In this example, it is determined from the metadata that the physical location of file 1 is in the folder 1006-1 of the first client device 1002-1. As such, the RTC management system sends an instruction to the first RTC application 1003-1 executing on the first client device 1002-1 to cause the first file 1008-1 to be played from the first client device 1002-1, as in 1000-23.

Referring now to FIG. 10F, in response to receiving the instructions, the first RTC application 1003-1 executing on the first client device 1002-1 causes the first file to be streamed 1055 to each of the client devices 1002-1, 1002-2, 1002-3 as part of the RTC room 1050 and RTC session, as in 1000-24. In addition, file controls 1057 may be presented and accessible to each client device, thereby allowing each client device to simultaneously impart control over the access of the file. For example, any of the client devices, while viewing the streaming 1055 playback of the first file may select one of the file controls, such as a play control, pause control, stop control, fast forward control, rewind control, slow motion control, etc., and that control will be performed with respect to the accessed file and perceived by each client device participating in the RTC room 1050. For example, the third client device 1002-3 may interact with the file controls 1057 and select to pause the playback of the first file, as in 1000-25. In response, the RTC management system 1001 again determines the physical location of the first file, in this example the first client device, and sends the issued control instruction to the client device at which the file is physically located, as in 1000-26. The RTC application executing on that client device performs the control instructions with respect to the file, in this example pausing playback of the file, as in 1000-27.

By presenting the file controls to each client device participating the RTC session, each client device can impart control over a file viewed or presented to each client device, regardless of the physical location of the file. In addition, in some implementations, annotations, comments, markings, or other input may be provided by any of the client devices with respect to the RTC room and the accessed file. For example, referring to FIG. 10G, after the third client device has paused the playback of the first file, which was streaming from the first client device, the third client device annotates 1059 a portion of this file, again as if the file were stored by the RTC management system as part of the RTC room, as in 1000-28. In this example, the annotation 1059 created by the third client device is presented in the RTC room as part of the RTC session such that each other client device accessing the RTC room perceives the annotation concurrently. In addition, the RTC management system stores the annotation and metadata regarding the annotation as part of the RTC room/RTC session, as in 1000-29. For example, the metadata may indicate a timestamp within the first file, or a frame or shot of the first file, at which the annotation was generated, position information regarding the annotation, the source of the annotation, etc. By storing the annotation and metadata about the annotation, even though the annotation does not become part of the first file that is being viewed, the annotation and corresponding metadata can be used later as part of the RTC room to recreate the annotation of the first file with the annotation, as discussed further below.

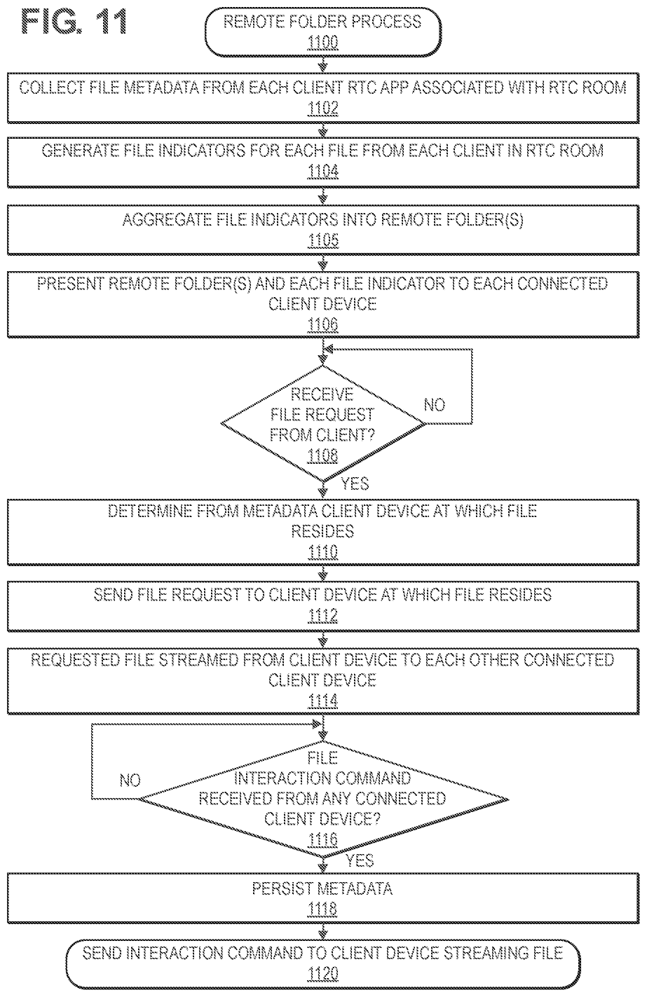

FIG. 11 is an example remote folder process 1100, in accordance with implementations of the present disclosure.

The example process 1100 begins by collecting file metadata from each client RTC application executing on each client device that is accessing or associated with an RTC room, as in 1102. As discussed above, an RTC application executing on a client device may have access to one or more files and/or folders retained in memory of that client device. For each accessible file, the RTC application may obtain and provide file metadata about the file, such as the file location, file type, file size, file name, file creation date, etc.

For each file stored on a client device for which file metadata has been received, a file indicator is generated based on the file metadata, as in 1104. The file indicator may be a visual representation of the file that is presented as part of the RTC room even though the file itself remains stored and secured on the client device. The file indicators for each of the files stored on the different client devices may be aggregated into one or more remote folders, as in 1105. For example, regardless of the actual location of the files, the file indictors may be aggregated into a single folder for presentation together as part of the RTC room. The remote folder and corresponding file indicators may then be presented as part of an RTC room/RTC session to each client device connected to or participating in the RTC room/RTC session, as in 1106. In some implementations, all client devices included in an RTC room/RTC session may have access to and be able to view the RTC folder and file indicators. In other implementations, an RTC room organizer may be able to specify which client devices can view and/or access the remote folders and/or file indicators.

As the file indicators are being presented, a determination is made as to whether a file request for a file represented by a file indicator has been received from one of the client devices participating in the RTC session, as in 1108. A file request may be any type of file request with regard to a file and may vary, for example, depending on the type of file. For example, if the file is a video file, the file request may be a play request. As another example the file may be a document and the file request may be a request to open the document for review by participants of the RTC session/RTC room.

If it is determined that a file request has not been received, the example process may remain at decision block 1108. If it is determined that a file request has been received, the metadata corresponding to the selected file indicator is queried to determine the client device at which the file is actually stored, as in 1110. As noted above, metadata may include information about the file, such as the physical location of the file represented by a file indicator.

In response to determining the file location at a client device at which the file physically resides, the file request is sent to the client device at which the file is stored, as in 1112. In some implementations, the file request may be sent to an RTC application executing on the client device at which the file is stored. In such an example, the RTC application executing on the client device, upon receiving the file request, may access the file and perform the file request, such as to play the file.

In addition to performing the file request, the client device streams the requested file to each of the other client devices participating in the RTC session and as part of the RTC room, as in 1114. For example, the RTC application executing on the client device that stores the requested file, may perform the file request, such as play the file and stream a playing of the file to each of the other client devices as part of the RTC session. By streaming the file, rather than transferring the entire file, the actual file remains on the client device and under the security of the client device.

As the file is streamed, a determination is made as to whether a file interaction command has been received from any connected device that is viewing the file and participating in the RTC session, as in 1116. For example, a file control may be presented to each client device as part of the streaming of the accessed file and each client device may be able to concurrently submit file controls to control the streamed file. For example, if the streamed file is a video file, the file controls may include, but are not limited to, a play of the file, a pause of the file, a stop of the file, a fast forward of the file, a rewind of the file, a slow motion of the file, etc. In other implementations, the file interaction command may be an annotation of a frame of the file, an edit, a comment with respect to a frame or shot of the file, etc. A user at any of the client devices can generate a file interaction command through interaction with the file control. In other implementations, other types of interaction commands may be received and performed with the disclosed implementations, as discussed herein.

If it is determined that a file interaction command is not received, the example process may remain at decision block 1116. However, upon receipt of a file interaction command from a client device, metadata corresponding to the file interaction command (an event) may be persisted as part of the RTC session, as in 1118. The metadata may provide information relating to the file interaction command, such as a timestamp as to when the file interaction command we received, a frame or shot of the streamed file presented as part of the RTC session when the file interaction command is received, etc. In addition, the file interaction command may be sent to the client device streaming the file so that the command is performed with respect to the file, as in 1120. For example, if the file interaction command is to pause a playback of the file, the file interaction command to pause may be sent to the RTC application executing on the client device at which the file physically resides, and the RTC application may perform the file interaction command, such as pause a playback of the file.

The example process 1100 may be continually performed during any RTC session allowing multiple files to be accessed by any of the connected client devices, regardless of the physical location of those files, interactions to be performed with respect to selected files, etc.

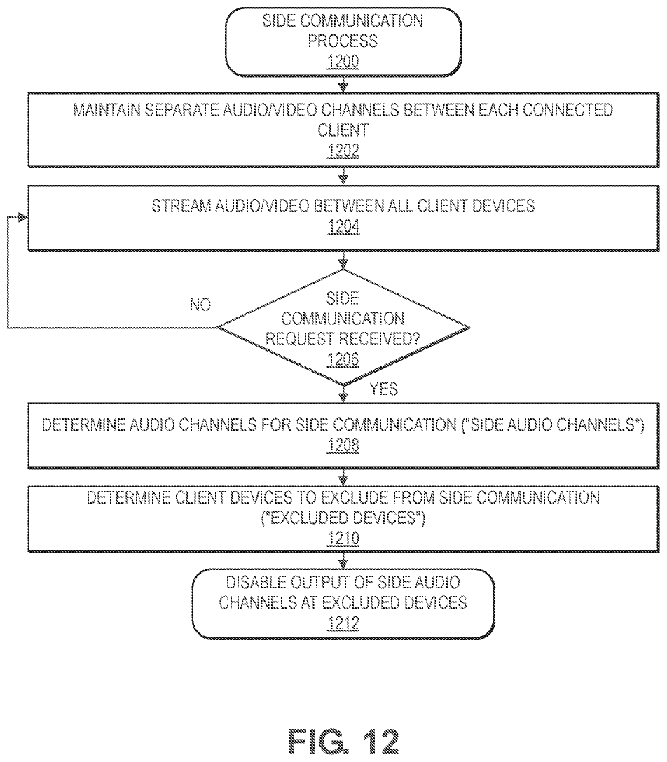

FIG. 12 is an example side communication process 1200, in accordance with implementations of the present disclosure. The example process may be performed at any time during an RTC session by two or more client devices included in an RTC session.

The example process 1200, as part of the normal RTC session, maintains separate audio channels and video channels between each client device participating in an RTC session, as in 1202. As those channels are active, audio data and video data is streamed between each client device so that all client devices are receiving and outputting audio data and video data received from each of the other client devices participating in the RTC session, as in 1204.

As the audio data and video data is streamed between each client device, a determination is made as to whether a side communication request has been received, as in 1206. A side communication, as used herein, is any audio and/or video communication that is part of a current RTC session that includes less than all client devices of the RTC session, without establishing another RTC session. For example, as discussed below, if there are three client devices included in an RTC session, a side communication between two of those client device may be established as part of the RTC session during which those two client device receive and output audio data from all client devices of the RTC session but the third client device does not output audio data from the first two client devices.

If it is determined at decision block 1206 that a side communication request has not been received, the example process 1200 returns to block 1204 and continues. However, if a side communication request is received, the audio channels (referred to herein as side audio channels), and optionally the video channels (referred to herein as side video channels) to include in the side communication are determined, as in 1208. Likewise, the client devices to exclude from the side communication are determined, referred to herein as excluded devices, as in 1210.

Finally, for the client devices to be excluded from the side communication, the output of the audio data, and optionally the video data, received from the side audio channels are disabled or muted so that audio data from those channels is not output to the excluded client device, as in 1212. For example, and continuing with the above example, if there are three client devices (device 1, device 2, device 3) included in an RTC session and device 1 and device 2 desire to have a side communication as part of the RTC session, the audio side channels between device 1 and device 2 are identified as the side audio channels and client device 3 is identified as the client device to be excluded from the side communication. To enable the side communication as part of the RTC session, the audio data from client 1 to client 2 is active and output to client 2, the audio data from client 2 to client 1 is active and output to client 1, the audio data from client 3 to client 1 is active and output to client 1, the audio data from client 3 to client 2 is active and output to client 2, the audio data from client 1 to client 3 is disabled such that the audio data from client 1 is not output to client 3, and the audio data from client 2 to client 3 is disabled such that the audio data from client 2 is not output to client 3. In such a configuration, client 1 and client 2 are still receiving and outputting audio data from each of the other client devices included in the RTC session but client 3 is not outputting audio data received from client 1 or client 2. In some implementations, the audio data from client 1 and client 2 may not be sent to client 3. In other implementations, the audio data from client 1 and client 2 may be sent to client 3 but may not be output at client 3.

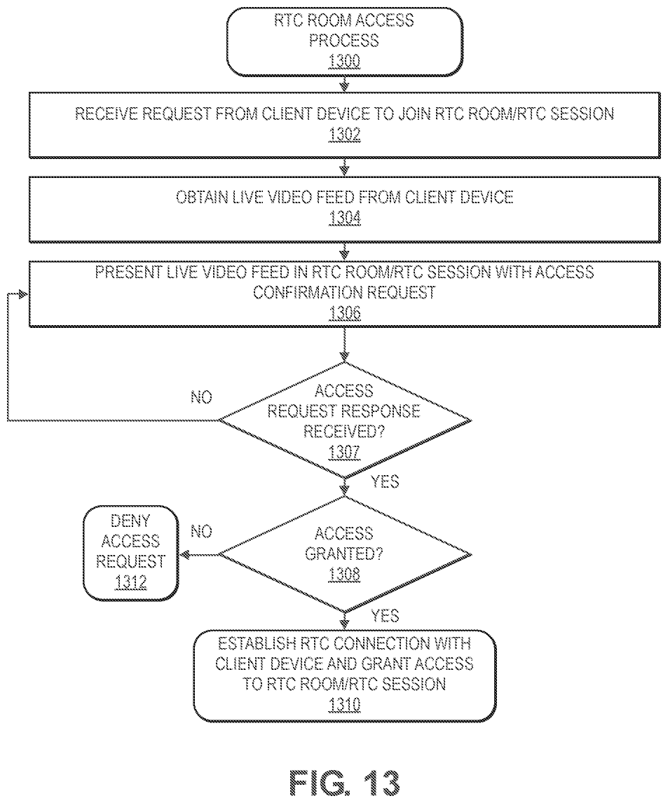

FIG. 13 is an example RTC room access process 1300, in accordance with implementations of the present disclosure.

The example process 1300 begins upon receipt of a request from a client device to join an RTC session or RTC room as in 1302. As discussed above, rather than requiring a requesting party to remember and input a password or other code to obtain access to an RTC session or RTC room, the example process may obtain a live video feed from the client device that is requesting access, as in 1304. For example, an RTC application executing on the client device may activate a camera of the client device and send a live video feed from the camera to the RTC session/RTC room.

The received video feed from the requesting client device may be presented to one or more of the client devices included in the RTC session/RTC room, as in 1306. In some implementations, the live video from the client device may be presented as part of the RTC room and all client devices may be able to view the live video feed and optionally select whether to grant or deny access to the client device. In other implementations, the live video may be sent to an organizer of the RTC session, or another designated client device.

As the live video is presented, a determination is made as to whether an access request response has been received, as in 1307. If it is determined that an access request response has not been received, the example process 1300 returns to block 1306 and presentation of the live video continues. In some implementations, a request timer may also be maintained and the video feed and access request only presented for a defined period of time. If the defined period of time (e.g., 1 minute) expires without an access response being received, the example process 1300 may terminate and the access request may be denied. In other implementations, if an access request response is not received within the defined period of time, an audible alert may be output to the RTC session/RTC room and/or the live video feed may be sent to a different client device of the RTC session/RTC room in an effort to obtain an access response.

If it is determined at decision block 1307 that an access request response has been received, a determination is made as to whether the access request is granted, as in 1308. If it is determined that the access request is granted, an RTC session is established between the requesting client device and each of the other client devices included in the RTC session, as in 1310. If the RTC session is denied, the request for access by the requesting client device is denied, as in 1312.

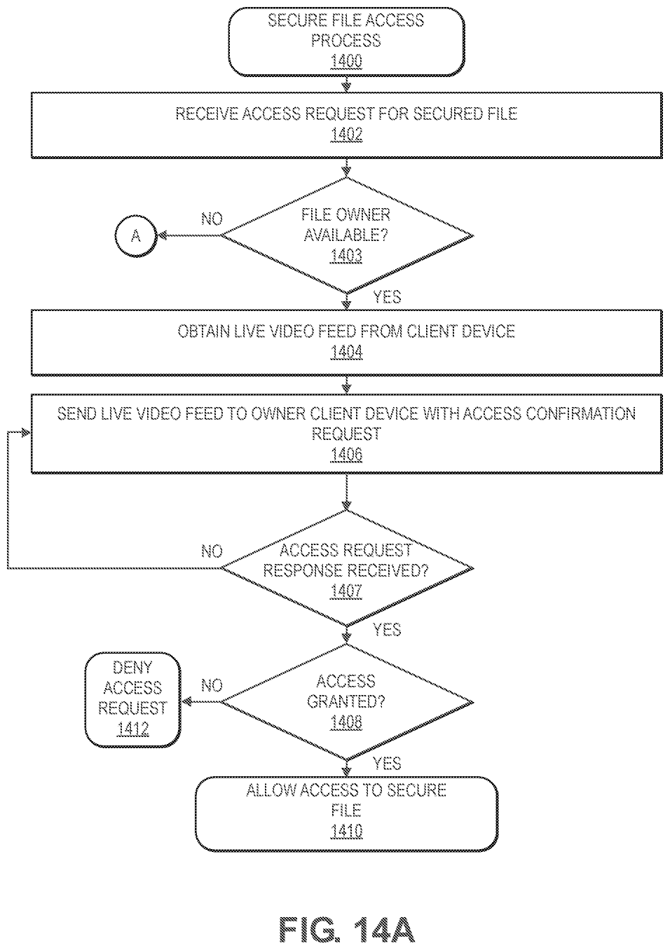

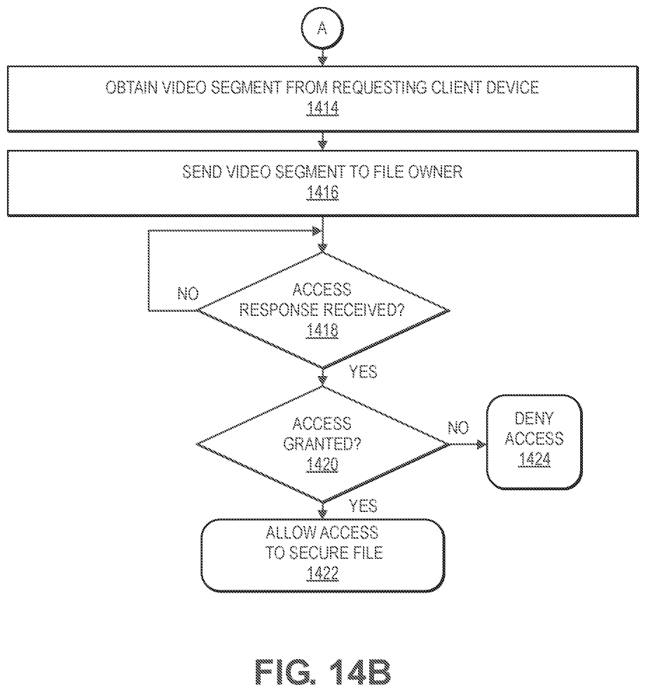

FIGS. 14A through 14B is an example secure file access process 1400, in accordance with implementations of the present disclosure.

The example process 1400 begins upon receipt of an access request for a secured file, as in 1402. Rather than require a client to remember a password or other access request, the disclosed implementations allow for visual verification.

In this example, a determination is made as to whether the file owner of the file for which the access request was made is available, as in 1403. In some implementations, a file owner may be determined available, or potentially available, based on status information provided by one or more devices and/or applications associated with the file owner.

If it is determined that the file owner is available, a live video feed is obtained from the client device that is requesting access to the secured file, as in 1404. For example, a notification or request may be sent to the client device requesting access to a camera of the client device and live video data may be obtained from the camera of the requesting client device. The obtained live video feed may then be sent to the client device of the owner of the secure file and presented on the owner client device with a request for a confirmation as to whether the requesting client device can access the secure file, as in 1406.

As the live video is presented, a determination is made as to whether an access request response has been received, as in 1407. If it is determined that an access request response has not been received, the example process 1400 returns to block 1406 and presentation of the live video continues. In some implementations, a request timer may also be maintained and the video feed and access request only presented for a defined period of time. If the defined period of time (e.g., 1 minute) expires without an access response being received, the example process 1400 may terminate and the access request may be denied. In other implementations, if an access request response is not received within the defined period of time, an audible alert may be output on the owner client device in an effort to obtain an access response. As another example, if an access request response is not received within the defined period of time, it may be determined that the owner of the secure file is not available, the live video feed terminated, and the example process 1400 may return to block 1403 and proceed as if the owner of the secure file is not available.

If it is determined at decision block 1407 that an access request response has been received, a determination is made as to whether the access request is granted, as in 1408. If it is determined that the access request is granted, access to the secure file is allowed by the requesting client device, as in 1410. In some implementations, the access may be unlimited for the requesting client device and/or a user of the requesting client device. In other implementations, the access may be for a defined period of time. If it is determined that the response is a denial of the request, then access to the secure file is denied, as in 1412.

Returning to decision block 1403, if it is determined that the file owner is not available, rather than send a live video feed to the owner client device, a video segment from the requesting client device is obtained, as in 1414 (FIG. 14B). The video segment may be any defined period of time that is sufficient to capture video data of a user at the requesting client device that is requesting access to the secure file. For example, the video segment may be ten seconds, shorter than ten seconds, or longer than ten seconds.

The obtained video segment may then be sent to the file owner for review and response as to whether the requesting client device is to be granted access to the secure file, as in 1416. The transmission of the video segment may be, for example, via email, text message, video message, post to an RTC room, etc.

After the video segment has been sent to the file owner for review and verification, a determination is made as to whether an access request response has been received, as in 1418. If an access request response has not been received, the example process 1400 remains at decision block 1418 and awaits an access request response.

If it is determined than an access request response has been received, a determination is made as to whether access has been granted to the client device requesting access to the secure file, as in 1420. If it is determined that the access request is granted, access to the secure file is allowed by the requesting client device, as in 1422. In some implementations, the access may be unlimited for the requesting client device and/or a user of the requesting client device. In other implementations, the access may be for a defined period of time. If it is determined that the response is a denial of the request, then access to the secure file is denied, as in 1424.

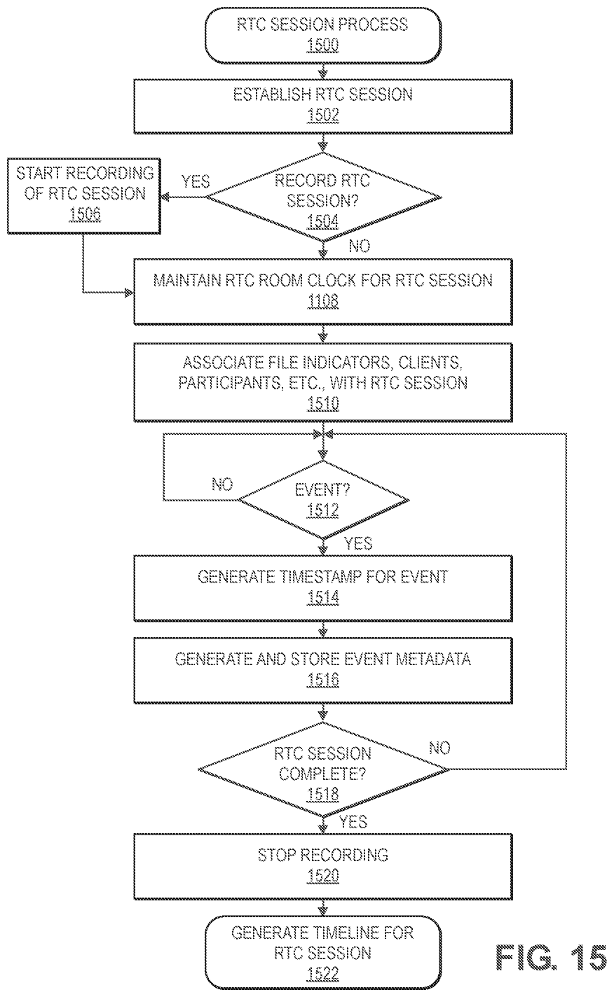

FIG. 15 is an example RTC session process 1500, in accordance with implementations of the present disclosure. The example process 1500 may be performed during any portion of or all of an RTC session for an RTC room. In such a configuration, an RTC room may have multiple RTC sessions. In other implementations, the example process may continue as long as the RTC room is active, with a single RTC session lasting for the duration of the RTC room.

The example process 1500 begins by establishing an RTC session, as in 1502. As discussed herein, an RTC session may be any duration or period of time during which one or more client devices are connected to an RTC room. For example, a first client device may join or create an RTC room. When the client device joins the RTC room, the RTC session may be established. Alternatively, the RTC session may be established with the creation of the RTC room and continue until the RTC room is closed or completed.

The example process 1500 may also determine if the RTC session is to be recorded, as in 1504. A recording of an RTC session may be an audio and/or video recording of the RTC session that is stored in a memory, such as a memory of the RTC management system, and accessible later to review the RTC session. If it is determined that the RTC session is to be recorded, the recording of the RTC session is initiated, as in 1506.

After initiating recording of the RTC session, or if it is determined that the RTC session is not to be recorded, an RTC room clock, also referred to herein as a global clock or a synchronization clock, is maintained, as in 1508.

In addition to establishing an RTC room clock, file indicators, client devices connected to the RTC room during the RTC session, users corresponding to the client device, and/or other information related to the RTC room/RTC session is associated with the RTC session, as in 1510. In general, all information related to the RTC session/RTC room may be indicated as metadata and associated with the RTC session.

As the RTC session continues, a determination is made as to whether an event has occurred as part of the RTC session, as in 1512. An event may be anything relating to the RTC session such as, but not limited to, a user/client device joining the RTC room during the RTC session, a selection of a file indictor to access a file represented by the file indicator, a side communication between two or more participants of the RTC session, an annotation or comment for a file being accessed during the RTC session, a playback, pause, rewind, fast forward, etc., of a file being accessed as a playback during the RTC session, etc.

If it is determined that an event has not occurred, the example process 1500 remains at decision block 1512. However, upon determination of an event during the RTC session, a timestamp corresponding to the RTC room clock is generated for the occurrence of the event, as in 1514, and metadata about the event (including the timestamp) is generated and stored, as in 1516. The metadata may be all information relating to the event, such as a file involved in the event, a position within a file when the event occurred, the type of event, users involved in the event, the event duration, etc.

After creation and storage of the metadata corresponding to an event, a determination is made as to whether the RTC session is complete, as in 1518. If it is determined that the RTC session has not completed, the example process returns to decision block 1512 and continues by monitoring for a next event. If it is determined that the RTC session has completed, if the RTC session was being recorded, the recording of the RTC session is stopped, as in 1520. In addition to stopping a recording of the RTC session, or if recording did not occur, a timeline representative of the RTC session and each timestamped event that occurred during the RTC session is generated for the RTC session, as in 1522. As discussed herein, the timeline for an RTC session may be utilized as an overview or summary of the RTC session and, in some implementations, may be interactive in that a user may select a timestamp or event indicator in the timeline and the event corresponding to the indicator may be re-created based on the metadata corresponding to the event.

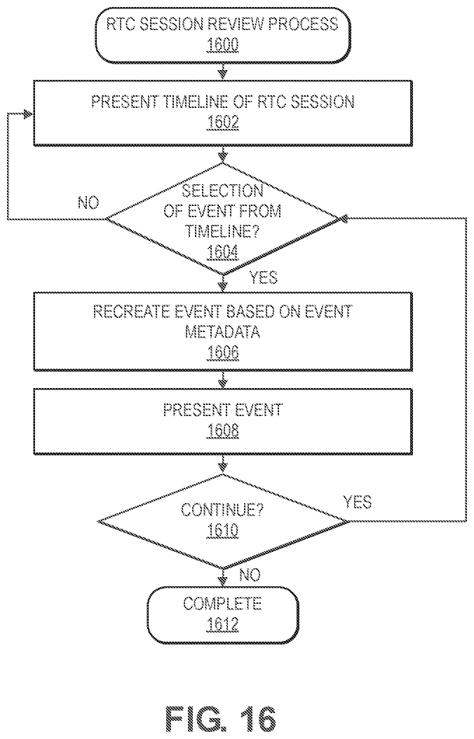

FIG. 16 is an example RTC session review process 1600, in accordance with implementations of the present disclosure. The example process 1600 may be performed after completion of any RTC session and generation of an RTC session timeline for that RTC session.

The example process 1600 begins by presenting a timeline of an RTC session, as in 1602. In some implementations, the RTC session corresponding to the timeline may be a completed RTC session and the timeline may represent some or all of the RTC session. In other implementations, for example, if an RTC session endures throughout the duration of an RTC room, the timeline may represent all or a portion of the RTC session up to a point in time, such as up to the point of access of the timeline by the example process 1600, or up to a last recorded event as part of the RTC session, etc.

Upon presentation of the timeline, a determination is made as to whether an event indicated on the timeline has been selected, as in 1604. As discussed above, each event occurring during an RTC session may be timestamped and indicated on the timeline for the RTC session. If it is determined that the event selection has not occurred, the example process 1600 returns to block 1602 and continues. If it is determined that a selection of an event from the timeline has occurred, the event corresponding to the selection is recreated based on the event metadata generated at the time of the event during the RTC session, as in 1606, and presented to the user, as in 1608.

For example, if the event is a user annotating a paused frame of a video, the relevant portions of the frame of video may be accessed from the source location of the video (e.g., a client device storing the video), the annotation may be obtained from memory of the RTC management system, and the paused frame of the video and corresponding annotation may be overlaid and presented to a user as if the event had occurred. Likewise, in some implementations, the user may interact with the event, moving forward or backward in time with respect to the event. For example, the event may have a time duration, such as five minutes, and the user may progress through the event as the event occurred during the RTC session. In other examples, if the RTC session was recorded, the user, upon selection of the event, may be presented with a relevant portion of the recording of the RTC session such that the user can view the event during the RTC session.

After the event is recreated and presented, a determination is made as to whether the example process 1600 is to continue for the presented timeline, as in 1610. For example, if the timeline continues to be presented, it may be determined that the example process 1600 is to continue. If it is determined that the example process 1600 is to continue, the example process 1600 returns to block 1604 and monitors for selection of another event from the timeline. If it is determined that the example process is not to continue, the example process 1600 completes, as in 1612.

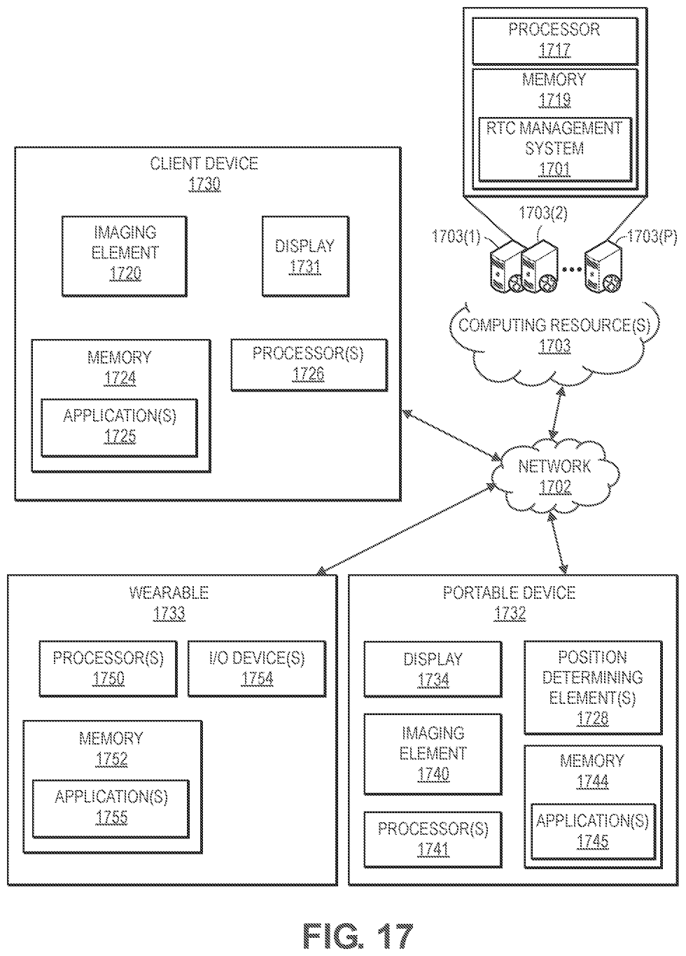

FIG. 17 is a block diagram of example components of a client device 1730, a portable device 1732, a wearable device 1733, and remote computing resources 1703, in accordance with implementations of the present disclosure.

As illustrated, the portable device may be any portable device 1732 such as a tablet, cellular phone, laptop, etc. The imaging element 1740 of the portable device 1732 may comprise any form of optical recording sensor or device that may be used to photograph or otherwise record information or data. As is shown in FIG. 17, the portable device 1732 is connected to the network 1702 and includes one or more memory 1744 or storage components (e.g., a database or another data store), one or more processors 1741, and one or more position/orientation/angle determining elements 1728, an output, such as a display 1734, speaker, haptic output, etc. The portable device 1732 may also connect to or otherwise communicate with the network 1702 through the sending and receiving of digital data.

The portable device 1732 may be used in any location and any environment to generate and send identity information to the RTC management system 1701 and/or to generate images of color cards and the display of a client device 1730. The portable device 1732 may also include one or more applications 1745, such as a streaming video player, identity information collection application, user authentication application, etc., each of which may be stored in memory that may be executed by the one or more processors 1741 of the portable device to cause the processor of the portable device to perform various functions or actions. For example, when executed, the application 1745 may generate image data and location information (e.g., identity information) and provide that information to the RTC management system 1701.

The application 1745, upon generation of identity information, images of a color card and display of the client device 1730, etc., may send the information, via the network 1702, to the RTC management system 1701 for further processing.

The client device 1730, which may be similar to the portable device, may include an imaging element 1720, such as a camera, a display 1731, a processor 1726, and a memory 1724 that stores one or more applications 1725, such as an RTC application. The application 1725 may communicate, via the network 1702, with the RTC management system 1701, an application 1745 executing on the portable device 1732, and/or an application 1755 executing on the wearable device 1733. For example, the application 1725 executing on the client device 1730 may periodically or continuously communicate with an application 1745 executing on the portable device 1732 and/or an application 1755 executing on the wearable device 1733 to determine the location of the portable device 1732 and/or the wearable device 1733 with respect to the client device 1730. As another example, the application 1725 may send and/or receive streaming video data and present the same on the display 1731 of the client device 1730. In still other examples, the application 1725 executing on the client device 1730 may change the framerate and/or compression in response to a trigger event and/or generate a high resolution image upon detection of the trigger event and start/stop streaming of the content.

The wearable device 1733 may be any type of device that may be carried or worn by a participant. Example wearable devices include, but are not limited to, rings, watches, necklaces, clothing, etc. Similar to the portable device 1732 and the client device 1730, the wearable device 1733 may include one or more processors 1750 and a memory 1752 storing program instructions or applications that when executed by the one or more processors 1750 cause the one or more processors to perform one or more methods, steps, or instructions. Likewise, the wearable device may include one or more Input/Output devices 1754 that may be used to obtain information about a participant wearing the wearable device and/or to provide information to the participant. For example, the I/O device 1754 may include an accelerometer to monitor movement of the participant, a heart rate, temperature, or perspiration monitor to monitor one or more vital signs of the participant, etc. As another example, the I/O device 1754 may include a microphone or speaker.

Generally, the RTC management system 1701 includes computing resource(s) 1703. The computing resource(s) 1703 are separate from the portable device 1732, the client device 1730 and/or the wearable device 1733. Likewise, the computing resource(s) 1703 may be configured to communicate over the network 1702 with the portable device 1732, the client device 1730, the wearable device 1733, and/or other external computing resources, data stores, etc.

As illustrated, the computing resource(s) 1703 may be remote from the portable device 1732, the client device 1730, and/or the wearable 1733, and implemented as one or more servers 1703(1), 1703(2), . . . , 1703(P) and may, in some instances, form a portion of a network-accessible computing platform implemented as a computing infrastructure of processors, storage, software, data access, and so forth that is maintained and accessible by components/devices of the RTC management system 1701, the portable device 1732, client devices 1730, and/or wearable devices 1733, via the network 1702, such as an intranet (e.g., local area network), the Internet, etc.

The computing resource(s) 1703 do not require end-user knowledge of the physical location and configuration of the system that delivers the services. Common expressions associated for these remote computing resource(s) 1703 include “on-demand computing,” “software as a service (SaaS),” “platform computing,” “network-accessible platform,” “cloud services,” “data centers,” and so forth. Each of the servers 1703(1)-(P) include a processor 1717 and memory 1719, which may store or otherwise have access to an RTC management system 1701.

The network 1702 may be any wired network, wireless network, or combination thereof, and may comprise the Internet in whole or in part. In addition, the network 1702 may be a personal area network, local area network, wide area network, cable network, satellite network, cellular telephone network, or combination thereof. The network 1702 may also be a publicly accessible network of linked networks, possibly operated by various distinct parties, such as the Internet. In some implementations, the network 1702 may be a private or semi-private network, such as a corporate or university intranet. The network 1702 may include one or more wireless networks, such as a Global System for Mobile Communications (GSM) network, a Code Division Multiple Access (CDMA) network, a Long Term Evolution (LTE) network, or some other type of wireless network. Protocols and components for communicating via the Internet or any of the other aforementioned types of communication networks are well known to those skilled in the art of computer communications and, thus, need not be described in more detail herein.

The computers, servers, devices and the like described herein have the necessary electronics, software, memory, storage, databases, firmware, logic/state machines, microprocessors, communication links, displays or other visual or audio user interfaces, printing devices, and any other input/output interfaces to provide any of the functions or services described herein and/or achieve the results described herein. Also, those of ordinary skill in the pertinent art will recognize that users of such computers, servers, devices and the like may operate a keyboard, keypad, mouse, stylus, touch screen, or other device (not shown) or method to interact with the computers, servers, devices and the like.

The RTC management system 1701, the application 1745, the portable device 1732, the application 1725, the client device 1730, the application 1755, and/or the wearable device 1733 may use any web-enabled or Internet applications or features, or any other client-server applications or features including E-mail or other messaging techniques, to connect to the network 1702, or to communicate with one another, such as through short or multimedia messaging service (SMS or MMS) text messages, Bluetooth, NFC, etc. For example, the servers 1703-1, 1703-2 . . . 1703-P may be adapted to transmit information or data in the form of synchronous or asynchronous messages from the RTC management system 1701 to the processor 1741 or other components of the portable device 1732, to the processor 1726 or other components of the client device 1730, and/or to the processor 1750 or other components of the wearable device 1733, or any other computer device in real time or in near-real time, or in one or more offline processes, via the network 1702. Those of ordinary skill in the pertinent art would recognize that the RTC management system 1701 may operate or communicate with any of a number of computing devices that are capable of communicating over the network, including but not limited to set-top boxes, personal digital assistants, digital media players, web pads, laptop computers, desktop computers, electronic book readers, cellular phones, and the like. The protocols and components for providing communication between such devices are well known to those skilled in the art of computer communications and need not be described in more detail herein.

The data and/or computer executable instructions, programs, firmware, software and the like (also referred to herein as “computer executable” components) described herein may be stored on a computer-readable medium that is within or accessible by computers or computer components such as the servers 1703-1, 1703-2 . . . 1703-P, one or more of the processors 1717, 1741, 1726, 1750, or any other computers or control systems, and having sequences of instructions which, when executed by a processor (e.g., a central processing unit, or “CPU”), cause the processor to perform all or a portion of the functions, services and/or methods described herein. Such computer executable instructions, programs, applications, software and the like may be loaded into the memory of one or more computers using a drive mechanism associated with the computer readable medium, such as a floppy drive, CD-ROM drive, DVD-ROM drive, network interface, or the like, or via external connections.

Some implementations of the systems and methods of the present disclosure may also be provided as a computer-executable program product including a non-transitory machine-readable storage medium having stored thereon instructions (in compressed or uncompressed form) that may be used to program a computer (or other electronic device) to perform processes or methods described herein. The machine-readable storage media of the present disclosure may include, but is not limited to, hard drives, floppy diskettes, optical disks, CD-ROMs, DVDs, ROMs, RAMs, erasable programmable ROMs (“EPROM”), electrically erasable programmable ROMs (“EEPROM”), flash memory, magnetic or optical cards, solid-state memory devices, or other types of media/machine-readable medium that may be suitable for storing electronic instructions. Further, implementations may also be provided as a computer executable program product that includes a transitory machine-readable signal (in compressed or uncompressed form). Examples of machine-readable signals, whether modulated using a carrier or not, may include, but are not limited to, signals that a computer system or machine hosting or running a computer program can be configured to access, or including signals that may be downloaded through the Internet or other networks.

Implementations disclosed herein may include a computer-implemented method. The computer-implemented method may include one or more of establishing an RTC session between a source device and a destination device to enable collaboration about a video between a first participant at the source device and a second participant at the destination device, playing the video on the source device so that the video is presented on a first display of the source device to the first participant as part of the collaboration, streaming the video as the video is played, via a first channel of the RTC session and at a first framerate and a first compression, from the source device to the destination device such that the destination device presents the video on a second display of the destination device to the second participant as part of the collaboration, and detecting a pause in the playing of the video. In addition, the computer-implemented may also include, in response to detecting the pause: terminating the streaming of the video, generating a high resolution image of the paused video, and sending the high resolution image from the source device to the destination device for presentation on the second display of the destination device instead of the streaming video, such that the second participant viewing the second display of the destination device is presented with the high resolution image of the paused video. Likewise, the computer-implemented method may also include, while the high resolution image is presented: maintaining the RTC session between the source device and the destination device, and enabling, via the RTC session, the collaboration, wherein the collaboration includes at least one of an audio communication between the first participant and the second participant or a visual annotation of the high resolution image by the second participant at the destination device that is sent through the RTC session and presented on the first display of the source device.

Optionally, the computer-implemented method may further include, subsequent to sending the high resolution image, detecting a second playing of the video at the source device, and in response to detecting the second playing of the video, resuming the streaming of the video as the video is played, via the first channel of the RTC session at the first framerate and the first compression, from the source device to the destination device such that the destination device presents the video on the second display of the destination device as the video is received. Optionally, the computer-implemented method may further include, in response to detecting the second playing of the video, causing the high resolution image to be removed from the second display of the destination device so that the streaming video is presented on the second display of the destination device. Optionally, the computer-implemented method may further include enabling, via a second channel of the RTC session, exchange of other visual information between the source device and the destination device. Optionally, the computer-implemented method may further include generating a first plurality of high resolution images corresponding to frames of the video that are before a frame used to generate the high resolution image, generating a second plurality of high resolution images corresponding to frames of the video that are after the frame used to generate the high resolution image, and sending the first plurality of high resolution images and the second plurality of high resolution images from the source device to the destination device.

Implementations disclosed herein may include a method. The method may include one or more of establishing an RTC session between a source device and a destination device to enable collaboration about a content between a first participant at the source device and a second participant at the destination device, playing the content on the source device so that the content is presented on a first display of the source device to the first participant as part of the collaboration, streaming the content as the content is played from the source device to the destination device, via a first channel of the RTC session and at a first framerate and a first compression, so that the destination device presents the content on a second display of the destination device as the content is received to the second participant as part of the collaboration, and detecting a first event corresponding to the content. In addition, the method may further include, in response to detecting the first event, transmitting from the source device and via the first channel of the RTC session, the content at a second framerate and a second compression so that the destination device presents the content on the second display at the second framerate and the second compression, wherein the second framerate and the second compression are different than the first framerate and the first compression. In addition, the method may further include, while the content is transmitted at the second framerate and the second compression: maintaining the RTC session between the source device and the destination device, and enabling, via the RTC session, the collaboration, wherein the collaboration includes at least one of an audio communication between the first participant and the second participant or a visual annotation of the content by the second participant at the destination device that is sent through the RTC session and presented on the first display of the source device.

Optionally, the first event may be a pause of the playing of the content. Optionally, the second framerate may be a lower framerate than the first framerate, and the second compression may be a lower compression than the first compression. Optionally, the source device may be at least one of a client device or an RTC management system. Optionally, the method may further include one or more or detecting a second event, and in response to the second event, resuming the streaming of the content, via the first channel of the RTC session at the first framerate and the first compression, from the source device to the destination device. Optionally, the second event may include a playing of the content at the source device. Optionally, a bandwidth of a connection between the source device and the destination device may remain substantially unchanged. Optionally, the method may further include obtaining, from an application executing on the source device, the content at the second framerate and the second compression. Optionally, the method may further include receiving, from the destination device, an instruction that causes the first event. Optionally, the method may further include enabling, via a second channel of the RTC session, exchange of other visual information between the source device and the destination device.

Implementations disclosed herein may include a computing system having one or more processors and a memory that stores program instructions. The program instructions, when executed by the one or more processors, may cause the one or more processors to establish a session between a source device and a destination device to enable collaboration about a video between a first participant at the source device and a second participant at the destination device, play the video on the source device so that the video is presented on a first display of the source device to the first participant as part of the collaboration, stream the video as the video is played at a first framerate and a first compression from the source device to the destination device such that the destination device presents the video on a second display of the destination device to the second participant as part of the collaboration, and/or detect a pause of the streaming of the video. The program instructions, when executed by the one or more processors may further cause the one or more processors to, in response to detection of the pause, alter the stream of the video from the first framerate and the first compression to a second framerate and a second compression, wherein the second framerate is lower than the first framerate and the second compression is lower than the first compression, and while the video is streamed at the second framerate and the second compression: maintain the session between the source device and the destination device, and enable, via the session, the collaboration, wherein the collaboration includes at least one of an audio communication between the first participant and the second participant or a visual annotation of the video by the second participant at the destination device that is sent through the session and presented on the first display of the source device.

Optionally, the program instructions, when executed by the one or more processors to cause the one or more processors to at least alter the stream of the video, may further include instructions that, when executed by the one or more processors, further cause the one or more processors to at least generate a high resolution image of the paused video, and send the high resolution image from the source device to the destination device at the second framerate and the second compression. Optionally, the program instructions, when executed by the one or more processors, may further cause the one or more processors to at least detect a play of the video, and in response to detection of the play, resume the stream of the video at the first framerate and the first compression. Optionally, the program instructions, when executed by the one or more processors, further cause the one or more processors to at least, in response to detection of the pause, obtain from an application executing on the source device, a high resolution image of the paused video, and wherein the altered stream of the video includes the high resolution image. Optionally, the high resolution image may be provided to the destination device for presentation on a display of the destination device while the video is paused.

Implementations disclosed herein may include a computer-implemented method. The computer-implemented method may include one or more of establishing an RTC session between a first device and a second device, receiving, from the first device, first metadata corresponding to a first file stored on the first device, generating, based at least in part on the first metadata, a first file indicator representative of the first file stored on the first device, receiving, from the second device, second metadata corresponding to a second file stored on the second device, generating, based at least in part on the second metadata, a second file indicator representative of the second file stored on the second device, consolidating, into a remote folder, at least the first file indicator and the second file indicator, presenting, concurrently to the first device and the second device, the remote folder that includes the first file indicator and the second file indicator, without obtaining the first file from the first device or the second file from the second device, and receiving, from the first device, a selection of the second file indicator representative of the second file stored on the second device. The computer-implemented method may further include, in response to receiving the selection, causing the second file, stored at the second device, to stream as part of the RTC session from the second device and be presented concurrently on the first device and the second device.

Optionally, the computer-implemented method may further include, as the second file is streaming, receiving, from a third device included in the RTC session, a file interaction command with respect to the streaming of the second file, and in response to receiving the file interaction command from the third device, causing the file interaction command to be performed by the second device to perform the interaction with respect to the streaming of the second file. Optionally, the file interaction command may be at least one of a play command, a rewind command, a fast forward command, a pause command, a slow motion command, or a stop command. Optionally, the computer-implemented method may further include one or more of receiving, from the first device and during the RTC session, an annotation corresponding to the second file streamed by the second device, maintaining a synchronization between the annotation and the second file, and storing the annotation and the synchronization as part of an RTC session record. Optionally, the computer-implemented method may further include one or more of determining a side communication to be enabled between the first device and a third device as part of the RTC session, disabling a first audio channel output to the second device such that audio from the first device is not output at the second device, disabling a second audio channel output to the second device such that audio from the third device is not output at the second device, maintaining a third audio channel output to the first device such that audio from the second device is output to the first device, maintaining a fourth audio channel output to the third device such that audio from the second device is output to the third device, maintaining a fifth audio channel output to the first device such that audio from the third device is output to the first device, and maintain a sixth audio channel output to the third device such that audio from the first device is output to the third device.

Implementations disclosed herein may include a method. The method may include one or more of establishing an RTC session between a plurality of devices, receiving, from a first device of the plurality of devices, first metadata corresponding to a first file stored on the first device, presenting, concurrently to each of the plurality of devices, a first file indicator representative of the first file stored on the first device, receiving, from a second device of the plurality of devices, a selection of the first file indicator representative of the first file stored on the first device, and in response to receiving the selection, causing the first file, stored at the first device, to stream as part of the RTC session from the first device and be presented concurrently to each of the plurality of devices.

Optionally, the first file may be a video file and/or the selection of the file indicator may include a request to play the first file. Optionally, the method may further include presenting, at each of the plurality of devices, a file controller such that any device of the plurality of devices can issue a file control command to control a streaming of the first file from the first device. Optionally, the method may further include one or more of receiving, from a third device of the plurality of devices, a file control command to alter a playback of the first file, and cause the file control command to be performed at the first device to alter the playback of the first file. Optionally, the method may further include one or more of receiving, during the RTC session, from a third device that is not participating on the RTC session, a request to join the RTC session, obtaining, from the third device a live video feed from a camera at the third device, presenting, to at least the first device of the plurality of devices, the live video feed and a request that an access be granted to the third device to join the RTC session, receiving, from the first device, an indication that access is to be granted to the third device, and in response to receiving the indication, including the third device in the RTC session. Optionally, the first device may be indicated as an organizer of the RTC session. Optionally, the method may further include one or more of receiving, from a third device of the plurality of devices, second metadata corresponding to a second file stored on the third device, consolidating the first file indicator and a second file indicator representative of the second file in a remote folder, and wherein presenting includes presenting, concurrently to each of the plurality of devices, the remote folder including the first file indicator and the second file indicator. Optionally, the method may further include one or more of receiving, during the RTC session and as the first file is streamed from the first device, an input from a third device with regard to the first file, synchronizing the input with a frame of the streaming of the first file concurrently presented to each of the plurality of devices at a time when the input is received, and storing metadata that includes the synchronization information and the input. Optionally, the method may further include recording the RTC session.

Implementations disclosed herein may include a computing system that has one or more processors and a memory storing program instructions. The program instructions, when executed by the one or more processors, may cause the one or more processors to establish a real-time communication (“RTC”) session between a plurality of devices, present, concurrently to each of the plurality of devices, a remote folder that includes at least: a first file indicator of a first file stored at a first device of the plurality of devices, and/or a second file indicator of a second file stored at a second device of the plurality of devices, receive, from a third device of the plurality of devices, a request to stream the first file, in response to the request, determine, based at least in part on metadata corresponding to the first file indicator, that the first file is stored at the first device, and/or send the request to stream the first file to the first device such that a streaming of the first file is initiated at the first device as part of the RTC session and concurrently presented to each of the plurality of devices.

Optionally, the program instructions, when executed by the one or more processors, may further include instructions that, when executed by the one or more processors, further cause the one or more processors to at least present at each of the plurality of devices and as the first file is streamed, a file controller such that any device of the plurality of devices can issue a file control command to control a streaming of the first file from the first device. Optionally, the file control command may enable at least one of a playing of the first file, a pausing of the first file, a stopping of the first file, a rewinding of the first file, a fast forward of the first file, or a slow motion of the first file. Optionally, the program instructions, when executed by the one or more processors, further cause the one or more processors to at least: receive, during the RTC session, from a fourth device that is not participating in the RTC session, a request to join the RTC session, obtain, from the fourth device, a live video feed from a camera at the fourth device, present, as part of the RTC session, the live video feed and a request that an access be granted to the fourth device to join the RTC session, receive, from at least one device of the plurality of devices, an indication that access is to be granted to the fourth device, and/or in response to receiving the indication, include the fourth device in the RTC session. Optionally, the program instructions when executed by the one or more processors further cause the one or more processors to at least receive from the first device, a first metadata corresponding to the first file, wherein the first metadata indicates at least a first location of the first file, and/or receiving, from the second device, a second metadata corresponding to the second file, wherein the second metadata indicates at least a second location of the second file. Optionally, the program instructions when executed by the one or more processors further cause the one or more processors to at least determine a side communication to be enabled between the first device and the second device of the RTC session such that audio between the first device and the second device is not output at the third device but audio from the third device is output to the first device and the second device, disable a first audio channel output to the third device such that audio from the first device is not output at the third device, disable a second audio channel output to the third device such that audio from the second device is not output at the third device, maintain a third audio channel output to the first device such that audio from the second device is output to the first device, maintain a fourth audio channel output to the second device such that audio from the first device is output to the second device, maintain a fifth audio channel output to the first device such that audio from the third device is output to the first device, and/or maintain a sixth audio channel output to the second device such that audio from the third device is output to the second device.

Visual Aspects of Chat Room—Mixed Reality

So-called augmented reality, mixed reality and virtual reality systems are becoming more commonplace. In some implementations, a chat system can be used in conjunction with a portable device or a wearable device that blends overlaid visuals with the system that is being used. For instance, the software can be combined with an augmented reality headset so as to render the other participants in the chat superimposed or surrounding the material that is being manipulated, such as video editing, as part of an RTC session. The augmented reality can be used to superimpose other aspects of the user interface, such as play controls, or color matching swatches or panels. Such controls and/or actions can be controlled through physical motions such as hand gestures, or controlled through voice commands understood by the system.

Notes and Chat Features and Machine Learning

In some implementations, the RTC management system may record notes and chats and synchronize those notes and chats, as well as transcribe the channel and synchronize the text of the transcript with the video using time stamps. A user can search for any word that is captured in the notes or transcript. “Fuzzy matching” (to accommodate for transcription spelling errors) and phonetic matching (finding words that sound like what is being searched for) may also be used to bring additional candidate matches. Clicking words on a timeline or in a chat or transcript window goes to that portion of video in playback. Clicking search results for a particular word may bring up that portion of video in playback.

Individual locations in a recording where a frame of a collaborative video can be bookmarked as part of the recording. The RTC management system may be unaware of what is being marked up, in the case that a user is sharing their screen. Alternatively the RTC management system may be specifically sharing a video file, in which case the RTC management system knows which frame of the video is being viewed at any given time. A moment in the recording can be bookmarked so that it can be returned to later. A frame that is drawn upon or annotated is automatically bookmarked. Any frame that is paused may also be bookmarked, through the system noting that the screen share is not changing significantly over time (except for cursor movement).

A visual horizontal or vertical strip illustrating and corresponding to the length of the recording can be used to randomly access portions of the recording of an RTC session. A cursor or visual indicator within the strip can indicate the location of the current playback within the recording. Dots, squares, or other different visual indicators can be placed on the strip to indicate bookmarks. Different visual indicators can indicate different types of bookmarks, such as points of discussion, stored still images, addition or departure of personnel in the recording, or the like.

An export can be done into a file, such as a PDF or document for download. The export will include all or a range of bookmarked areas. The export may contain not just stills but embedded animated videos (such as animated GIFs) links to online videos of the entire conversation leading up to and including that portion of video, etc. In this way, only the salient, discussed portions of a content review session will be summarized.

The export may be utilized as a proof (summary) page. Each annotated or bookmarked frame or paused frame may be included in the proof page. The proof page may contain a set of embedded videos, one for each conversation. For example, an entire two-hour movie review session might yield an hour of focused commentary, in five to ten minute segments, on portions of the content.

Alternatively, or in addition thereto, the summary page can be hosted on a shared, online web page, which includes the summarized relevant sections, rather than a downloadable PDF or other file.

A first user can access an RTC session, select a video file such, as a movie, play it through, annotate (using audio and video recording) the file to provide commentary (e.g., “directors commentary”) that the disclosed implementations may time stamp in association with the original file and an export file summarizing the inputs from the first user may be generated. Subsequently, a second user can access the export file and replay the commentary. The source of the video can be an uploaded video or a video stored on another content management system (e.g. DROPBOX, MICROSOFT AZURE, etc.).

In addition, a machine learning algorithm may be trained to categorize non-relevant audio chatter and conversation directly relating to the viewed content. Thus, the system can automatically create a summary page that can be enhanced by automatically based on outputs from the machine learning algorithm, thereby focusing on the key commentary. Other commentary that was filtered out can be included at the end, with rough transcripts, so that user can skim and see if the machine learning algorithm missed something critical.

Accessing Recordings and 2-Factor Security

People need to access recordings, but they are very sensitive because they have pre-release IP along with confidential commentary. Thus, security around sharing of clips such as “director's corrections to an edit.”

The system can be protected at one layer, by enforcing a form of two-factor authentication. Each time the user wants to access a recording, they are prompted for a 2FA code from an authenticator app or through a text message sent to a device they are known to possess. Alternately, a 2FA code can be sent to a custom authenticator application that also enforces other forms of security, such as requiring biometric security on the device, like a fingerprint or picture or video, using the built in authentication features of the mobile device. Or the 2FA can be in the form of a re-authentication of the person by having them look at a custom app and capturing their biometrics within that app, and then providing them with the authentication that they can transfer to the device they are trying to use to access the recording.

In another embodiment, the authentication can be sent to someone else. A requestor tries to access a recording using their login credentials. They are prompted to provide their image as video, requesting the video. The clip or image of the requestor is sent via text or to a custom application that is running on a producer or in-charge, authorized person who then indicates that they are allowed to access that clip. That indication of allowance travels up to the RTC management system and allows them to access the content.

Combinations might allow the clip to be recorded each time, and 2FA allows the user in, and all the accesses are integrated into a time lapse, which can be reviewed all at once by a supervisor to determine say, for a week, all the people who accessed content and determine if they should have been accessing it. This allows for rapid, periodic human security audits and ensures that every accessed recoding is accounted for.

In embodiments, recordings are only playable while continuously performing video biometric verification of the viewing user, and similar to conferencing, if the user looks away or walks away the playback of the recorded content is disabled.

Although the disclosure has been described herein using exemplary techniques, components, and/or processes for implementing the systems and methods of the present disclosure, it should be understood by those skilled in the art that other techniques, components, and/or processes or other combinations and sequences of the techniques, components, and/or processes described herein may be used or performed that achieve the same function(s) and/or result(s) described herein and which are included within the scope of the present disclosure.

It should be understood that, unless otherwise explicitly or implicitly indicated herein, any of the features, characteristics, alternatives or modifications described regarding a particular implementation herein may also be applied, used, or incorporated with any other implementation described herein, and that the drawings and detailed description of the present disclosure are intended to cover all modifications, equivalents and alternatives to the various implementations as defined by the appended claims. Moreover, with respect to the one or more methods or processes of the present disclosure described herein, including but not limited to the flow charts shown in FIGS. 6 through 9, orders in which such methods or processes are presented are not intended to be construed as any limitation on the claimed inventions, and any number of the method or process steps or boxes described herein can be combined in any order and/or in parallel to implement the methods or processes described herein. Also, the drawings herein are not drawn to scale.

Conditional language, such as, among others, “can,” “could,” “might,” or “may,” unless specifically stated otherwise, or otherwise understood within the context as used, is generally intended to convey in a permissive manner that certain implementations could include, or have the potential to include, but do not mandate or require, certain features, elements and/or steps. In a similar manner, terms such as “include,” “including” and “includes” are generally intended to mean “including, but not limited to.” Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation.

The elements of a method, process, or algorithm described in connection with the implementations disclosed herein can be embodied directly in hardware, in a software module stored in one or more memory devices and executed by one or more processors, or in a combination of the two. A software module can reside in RAM, flash memory, ROM, EPROM, EEPROM, registers, a hard disk, a removable disk, a CD-ROM, a DVD-ROM or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile. The processor and the storage medium can reside in an ASIC. The ASIC can reside in a device. In the alternative, the processor and the storage medium can reside as discrete components in a device.

Disjunctive language such as the phrase “at least one of X, Y, or Z,” or “at least one of X, Y and Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain implementations require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

Language of degree used herein, such as the terms “about,” “approximately,” “generally,” “nearly” or “substantially” as used herein, represent a value, amount, or characteristic close to the stated value, amount, or characteristic that still performs a desired function or achieves a desired result. For example, the terms “about,” “approximately,” “generally,” “nearly” or “substantially” may refer to an amount that is within less than 10% of, within less than 5% of, within less than 1% of, within less than 0.1% of, and within less than 0.01% of the stated amount.

Although the invention has been described and illustrated with respect to illustrative implementations thereof, the foregoing and various other additions and omissions may be made therein and thereto without departing from the spirit and scope of the present disclosure.

What is claimed is:

1. A computer-implemented method, comprising
establishing a real-time communication (“RTC”) session between a first device and a second device;
receiving, from the first device, first metadata corresponding to a first file stored on the first device;
generating, based at least in part on the first metadata, a first file indicator representative of the first file stored on the first device;
receiving, from the second device, second metadata corresponding to a second file stored on the second device;
generating, based at least in part on the second metadata, a second file indicator representative of the second file stored on the second device;
consolidating, into a remote folder, at least the first file indicator and the second file indicator;
presenting, concurrently to the first device and the second device, the remote folder that includes the first file indicator and the second file indicator, without obtaining the first file from the first device or the second file from the second device;
receiving, from the first device, a selection of the second file indicator representative of the second file stored on the second device; and
in response to receiving the selection, causing the second file, stored at the second device, to stream as part of the RTC session from the second device and be presented concurrently on the first device and the second device.

2. The computer-implemented method of claim 1, further comprising:
as the second file is streaming, receiving, from a third device included in the RTC session, a file interaction command with respect to the streaming of the second file; and
in response to receiving the file interaction command from the third device, causing the file interaction command to be performed by the second device to perform the interaction with respect to the streaming of the second file.

3. The computer-implemented method of claim 2, wherein the file interaction command is at least one of a play command, a rewind command, a fast forward command, a pause command, a slow motion command, or a stop command.

4. The computer-implemented method of claim 1, further comprising:
receiving, from the first device and during the RTC session, an annotation corresponding to the second file streamed by the second device;
maintaining a synchronization between the annotation and the second file; and
storing the annotation and the synchronization as part of an RTC session record.

5. The computer-implemented method of claim 1, further comprising:
determining a side communication to be enabled between the first device and a third device as part of the RTC session;
disabling a first audio channel output to the second device such that audio from the first device is not output at the second device;
disabling a second audio channel output to the second device such that audio from the third device is not output at the second device;
maintaining a third audio channel output to the first device such that audio from the second device is output to the first device;
maintaining a fourth audio channel output to the third device such that audio from the second device is output to the third device;
maintaining a fifth audio channel output to the first device such that audio from the third device is output to the first device; and
maintaining a sixth audio channel output to the third device such that audio from the first device is output to the third device.

6. A method, comprising:
establishing a real-time communication (“RTC”) session between a plurality of devices;
receiving, from a first device of the plurality of devices, first metadata corresponding to a first file stored on the first device;
presenting, concurrently to each of the plurality of devices, a first file indicator representative of the first file stored on the first device;
receiving, from a second device of the plurality of devices, a selection of the first file indicator representative of the first file stored on the first device; and
in response to receiving the selection, causing the first file, stored at the first device, to stream as part of the RTC session from the first device and be presented concurrently to each of the plurality of devices.

7. The method of claim 6, wherein:
the first file is a video file; and
the selection of the file indicator includes a request to play the first file.

8. The method of claim 6, further comprising:
presenting, at each of the plurality of devices, a file controller such that any device of the plurality of devices can issue a file control command to control a streaming of the first file from the first device.

9. The method of claim 8, further comprising:
receiving, from a third device of the plurality of devices, a file control command to alter a playback of the first file; and
causing the file control command to be performed at the first device to alter the playback of the first file.

10. The method of claim 6, further comprising:
receiving, during the RTC session, from a third device that is not participating on the RTC session, a request to join the RTC session;
obtaining, from the third device a live video feed from a camera at the third device;
presenting, to at least the first device of the plurality of devices, the live video feed and a request that an access be granted to the third device to join the RTC session;
receiving, from the first device, an indication that access is to be granted to the third device; and
in response to receiving the indication, including the third device in the RTC session.

11. The method of claim 10, wherein the first device is indicated as an organizer of the RTC session.

12. The method of claim 6, further comprising:
receiving, from a third device of the plurality of devices, second metadata corresponding to a second file stored on the third device;
consolidating the first file indicator and a second file indicator representative of the second file in a remote folder; and
wherein presenting includes presenting, concurrently to each of the plurality of devices, the remote folder including the first file indicator and the second file indicator.

13. The method of claim 6, further comprising:
receiving, during the RTC session and, as the first file is streamed from the first device, an input from a third device with regard to the first file;
synchronizing the input with a frame of the streaming of the first file concurrently presented to each of the plurality of devices at a time when the input is received; and
storing metadata that includes the synchronization information and the input.

14. The method of claim 6, further comprising:
recording the RTC session.

15. A computing system, comprising:
one or more processors; and
a memory storing program instructions that, when executed by the one or more processors, cause the one or more processors to at least:
establish a real-time communication (“RTC”) session between a plurality of devices;
present, concurrently to each of the plurality of devices, a remote folder that includes at least:
a first file indicator of a first file stored at a first device of the plurality of devices; and
a second file indicator of a second file stored at a second device of the plurality of devices;
receive, from a third device of the plurality of devices, a request to stream the first file;
in response to the request, determine, based at least in part on metadata corresponding to the first file indicator, that the first file is stored at the first device; and
send the request to stream the first file to the first device such that a streaming of the first file is initiated at the first device as part of the RTC session and concurrently presented to each of the plurality of devices.

16. The computing system of claim 15, wherein the program instructions, when executed by the one or more processors, further include instructions that, when executed by the one or more processors, further cause the one or more processors to at least:
present at each of the plurality of devices and, as the first file is streamed, a file controller such that any device of the plurality of devices can issue a file control command to control a streaming of the first file from the first device.

17. The computing system of claim 16, wherein the file control command enables at least one of a playing of the first file, a pausing of the first file, a stopping of the first file, a rewinding of the first file, a fast forward of the first file, or a slow motion of the first file.

18. The computing system of claim 15, wherein the program instructions, when executed by the one or more processors, further cause the one or more processors to at least:
receive, during the RTC session, from a fourth device that is not participating in the RTC session, a request to join the RTC session;
obtain, from the fourth device, a live video feed from a camera at the fourth device;
present, as part of the RTC session, the live video feed and a request that an access be granted to the fourth device to join the RTC session;
receive, from at least one device of the plurality of devices, an indication that access is to be granted to the fourth device; and
in response to receiving the indication, include the fourth device in the RTC session.

19. The computing system of claim 15, wherein the program instructions when executed by the one or more processors further cause the one or more processors to at least:
receive from the first device, a first metadata corresponding to the first file, wherein the first metadata indicates at least a first location of the first file; and
receiving, from the second device, a second metadata corresponding to the second file, wherein the second metadata indicates at least a second location of the second file.

20. The computing system of claim 15, wherein the program instructions when executed by the one or more processors further cause the one or more processors to at least:
determine a side communication to be enabled between the first device and the second device of the RTC session such that audio between the first device and the second device is not output at the third device but audio from the third device is output to the first device and the second device;
disable a first audio channel output to the third device such that audio from the first device is not output at the third device;
disable a second audio channel output to the third device such that audio from the second device is not output at the third device;
maintain a third audio channel output to the first device such that audio from the second device is output to the first device;
maintain a fourth audio channel output to the second device such that audio from the first device is output to the second device;
maintain a fifth audio channel output to the first device such that audio from the third device is output to the first device; and
maintain a sixth audio channel output to the second device such that audio from the third device is output to the second device.
